(19) United States
(12) Patent Application Publication
(10) Pub. No.: US 2026/0119809 A1
(43) Pub. Date: Apr. 30, 2026

(54) GENERATING MULTIMODAL ATTRIBUTION OF ARTIFICIAL INTELLIGENCE RESPONSES

(71) Applicant: Adobe Inc., San Jose, CA (US)

(72) Inventors: Anirudh Phukan, Bengaluru (IN); Koustava Goswami, Bangalore (IN); Divyansh ., Kanpur (IN); Harshit Kumar Morj, Mumbai (IN); Vaishnavi ., Kanpur (IN)

(21) Appl. No.: 18/927,104

(22) Filed: Oct. 25, 2024

(51) Int. Cl. G06F 40/40

(52) U.S. Cl. CPC G06F 40/40

(57) ABSTRACT

The present disclosure relates to systems, methods, and non-transitory computer-readable media that generates text and image attributions and provides for display in a digital document the image attribution of an image element and the text attribution of text in the digital document. In particular, the disclosed systems receive a prompt relative to a digital document, and in response, generates an answer to the prompt using a multimodal large language model. Furthermore, the disclosed systems generating an image attribution and a text attribution in response to a selection of at least a portion of the answer to the prompt. Specifically, the image attribution and the text attribution indicate portions of the digital document that provide support for the at least a portion of the answer. Moreover, the disclosed systems provide for display in the digital document of a client device, the image attribution and the text attribution.

### BACKGROUND

Recent years have seen significant advancement in question and answering systems. For example, existing software platforms provide an option to query a document and provide an answer to the query. For instance, existing software platforms provide an option to query a document with queries such as summarizing a document or explaining a certain part of a document. However, despite these advancements, existing software platform systems continue to suffer from a variety of problems.

### SUMMARY

One or more embodiments described herein provide benefits and/or solve one or more of the problems in the art with systems, methods, and non-transitory computer-readable media that performs multimodal attribution within a digital document for a selection of an artificial intelligence generated answer provided in response to a prompt relative to the digital document. For example, in one or more embodiments, the disclosed systems receive a prompt relative to a digital document (e.g., that includes text and image elements) and the disclosed systems generate an answer to the prompt. In response to a selection of at least a portion of the answer to the prompt, the disclosed systems generate attributions for both text and image information sources. In other words, the disclosed systems generate, utilizing deep learning, image attribution (e.g., of an image element) and a text attribution (e.g., of text) where both attributions indicate portions of the digital document that provide support for the selection of the at least a portion of the answer. Moreover, the disclosed systems provide for display (e.g., indicate) in the digital document, the image attribution of the image element and the text attribution of the text.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a multimodal attribution system operates in accordance with one or more implementations;

FIG. 2 illustrates an overview diagram of the multimodal attribution system providing for display an image attribution of an image element and a text attribution of a portion of text in a digital document in accordance with one or more implementations;

FIG. 3A illustrates a diagram of the multimodal attribution system generating an answer and receiving a selection of at least part of the answer in accordance with one or more implementations;

FIG. 3B illustrates a diagram of the multimodal attribution system performing a forward pass with a combined input through a multimodal large language model in accordance with one or more implementations;

FIG. 3C illustrates a diagram of the multimodal attribution system determining an image attribution and a text attribution in accordance with one or more implementations;

FIG. 4 illustrates a diagram of the utilizing a multimodal large language model with a plurality of intermediate layers to generate measures of similarity in accordance with one or more implementations;

FIG. 5 illustrates a diagram of the multimodal attribution system accessing hidden state embeddings from intermediate layers of a multimodal large language model in accordance with one or more implementations;

FIG. 6 illustrates a diagram of the multimodal attribution system generating hidden image embeddings in accordance with one or more implementations;

FIG. 7 illustrates a diagram of the multimodal attribution system utilizing a cross-modality attribution selection heuristic in accordance with one or more implementations;

FIGS. 8A-8E illustrates example graphical user interfaces of the multimodal attribution system performing attribution tasks in accordance with one or more implementations;

FIG. 9 illustrates a schematic diagram of the multimodal attribution system in accordance with one or more implementations;

FIG. 10 illustrates a flowchart of a series of acts for providing for display in a digital document of a client device, the image attribution and the text attribution in accordance with one or more implementations;

FIG. 11 illustrates a block diagram of an exemplary computing device in accordance with one or more implementations.

### DETAILED DESCRIPTION

One or more embodiments described herein include a fast, scalable, and inference-time system capable of generating, utilizing deep learning, attributions within a digital document for both text and image information sources in response to a selection of at least a portion of an artificial intelligence response. For example, a multimodal attribution system enables a more transparent and explainable artificial-intelligence assisted digital document analysis. Specifically, the multimodal attribution system provides an option for a client device to submit a prompt relative to a digital document (e.g., summarize this digital document; what is the infographic about? describe the details shown in the digital image) and the multimodal attribution system generates an artificial intelligence answer responsive to the prompt. Moreover, in one or more embodiments, the multimodal attribution system allows a client device to select a portion of the provided answer, and the multimodal attribution system further indicates portions in the digital document that provide support for the selection of the portion of the provided answer. In other words, in one or more embodiments, the multimodal attribution system highlights relevant text for a selection of a portion of a provided answer and also outlines (e.g., generates a bounding box attribution) an image region utilizing deep learning. Specifically, the highlighted relevant text and outlined image region indicates that these portions of the digital document provide support for the selection of the portion of the answer.

In one or more embodiments, the multimodal attribution system performs multimodal attribution by leveraging a multimodal large language model. In particular, the multimodal attribution system uses a multimodal large language model that processes and generates information across multiple modalities (e.g., text and visual data). For instance, the multimodal large language model uses deep learning architectures to establish correlations between diverse data types. Specifically, the multimodal large language model includes a vision encoder to extract salient features from image inputs (e.g., image elements that are encoded as a sequence of data, such as image tokens and processed by the multimodal large language model) within a digital document which is further coupled with a large language model that processes textual data. Thus, the multimodal attribution system utilizes the multimodal large language model which allows for a nuanced understanding of semantic relationships between visual elements and linguistic descriptions, facilitating a more sophisticated and context-aware interaction in question-answering environments and multimodal comprehension/generation.

In one or more embodiments, the multimodal attribution system utilizes intermediate layers of the multimodal large language model to generate hidden state embeddings. Specifically, hidden state embeddings refer to high-dimensional vector representations of intermediate computational stages within the neural network architecture. For instance, the multimodal attribution system accesses the hidden state embeddings from the intermediate layers of the multimodal large language model to perform cross-modal reasoning. In other words, the hidden state embeddings of the intermediate layers enable the multimodal attribution system to perform both text and image attribution for a selection of at least a portion of an answer. Thus, the hidden state embeddings facilitate the transfer of information between multiple modalities (e.g., text and visual modalities) to generate the text and image attributions. Accordingly, the multimodal attribution system leverages hidden state embeddings to perform a novel reasoning-based approach to identify attributions for both text and image elements (e.g., based on a selection of at least a portion of an artificial intelligence generated answer).

In one or more embodiments, the multimodal attribution system generates hidden text embeddings from text of the digital document and generates hidden image embeddings from images of the digital document (e.g., by accessing hidden state embeddings from the intermediate layers). Furthermore, in one or more embodiments, the multimodal attribution system compares the hidden text embeddings and the hidden image embeddings with the selection of at least a portion of the answer (e.g., a grounded portion of the answer) to generate measures of similarity. To illustrate, the multimodal attribution system takes the highest measures of similarity and uses them as the attributed portions within a digital document that provide support to a selection of at least a portion of the answer. In other words, the multimodal attribution system shows in a graphical user interface of a client device the attributed portions (e.g., determined from the hidden state embeddings) of image and/or text within the digital document.

In one or more embodiments, the multimodal attribution system further utilizes a cross-modality attribution selection heuristic. Specifically, based on the generated measures of similarity, the multimodal attribution system has access to candidate attribution results (e.g., candidate text attributions and/or candidate image attributions). Furthermore, based on the measures of similarity, the multimodal attribution system determines to provide for display only a text-span attribution, only an image-region attribution, or both a text span attribution and an image-region attribution.

As mentioned above, many conventional systems suffer from a number of issues in relation to accuracy, efficiency, and operational flexibility. Specifically, conventional systems suffer from inefficiencies in performing attribution tasks (e.g., attributing parts of a document with an artificial intelligence generated answer or a portion of an answer). For example, conventional systems only focus on the text modality. Thus, conventional systems are incapable of processing non-text modality inputs for performing attribution tasks.

Moreover, some conventional systems use retrieval-based attribution to perform attribution tasks. Specifically, retrieval-based attribution includes identifying relevant document sections using similarity scores between a question/answer and document parts. However, conventional systems that use this retrieval-based attribution approach fail to accurately pinpoint exact contributing text spans. Thus, in addition to failing to process and perform attribution tasks for non-text modality inputs, conventional systems also fail to accurately narrow in on exact support within a digital document for a generated answer.

Furthermore, conventional systems suffer from inefficiencies in performing attribution tasks. Specifically, conventional systems typically require training or fine-tuning to perform text attribution tasks. For instance, conventional systems typically need model specific and use case specific fine-tuning/training to perform attribution tasks. Because of this, conventional systems typically consume a large number of resources to prepare models for specific use cases (e.g., in question answering environments). Thus, conventional systems are inefficient in performing attribution tasks.

Moreover, conventional systems further suffer from inefficiencies in performing attribution tasks because many systems use answer decomposition and textual entailment. Specifically, conventional systems (e.g., performing attribution tasks) attempt to break down generated answers into smaller components and further uses dependency parsing and entailment models to match document spans. In other words, conventional systems spend a lot of time and resources to parse through a document and break it down into manageable components and then further uses parsing to determine relationships between various components. Especially in the instance of longer documents, conventional systems performing attribution tasks are computationally expensive.

Relatedly to the inaccuracy and inefficiency issues, conventional systems are also operationally inflexible. As mentioned above, conventional systems fail to extend to non-text modalities for attribution tasks and even for text modalities, conventional systems inaccurately and/or inefficiently generate text attributions. Thus, conventional systems fail to adapt to a wider range of scenarios and further fails to perform it in an accurate and efficient manner.

In one or more embodiments, the multimodal attribution system provides several improvements over conventional systems in relation to efficiency, accuracy, and operational flexibility. For example, in one or more embodiments, the multimodal attribution system improves upon accuracy relative to conventional systems. Specifically, the multimodal attribution system improves upon accuracy by performing attribution tasks for the text modality and visual modalities. In other words, the multimodal attribution system is capable of attributing parts of a document with an artificial intelligence generated answer or a portion of the answer to both text and image modalities. In contrast to conventional systems which only work with the text modality, the multimodal attribution system also accurately attributes image regions within a digital document that provides support for an answer (e.g., or a part of an answer).

Furthermore, in one or more embodiments, the multimodal attribution system improves upon accuracy by utilizing a multimodal large language model. In contrast to conventional systems, which use retrieval-based attribution (e.g., identify relevant document sections using similarity scores between a question/answer and document parts), the multimodal attribution system performs a forward pass through a multimodal large language model to generate hidden state embeddings from the intermediate layers of the multimodal large language model. In doing so, the multimodal attribution system accesses the hidden state embeddings (e.g., which contain cross-modality information) to determine portions of the digital document (e.g., both image and text) that provide the best support for an answer or a selected portion of an answer. By using the hidden state embeddings, the multimodal attribution system accurately pinpoints exact contributing text spans and exact contributing image regions.

Furthermore, in one or more embodiments, the multimodal attribution system improves computational efficiency relative to conventional systems. In contrast to conventional systems, which require training or fine-tuning to perform text attribution tasks, the multimodal attribution system generates image attributions and text attributions at inference time without allocating computing resources towards additional training or fine-tuning. Specifically, the multimodal attribution system possesses the capability of generating text and image attributions at inference time by leveraging hidden state embeddings generated from intermediate layers of a multimodal large language model.

In other words, in one or more embodiments, the multimodal attribution system uses the same model used to generate an artificial intelligence answer to also perform attribution tasks (e.g., by accessing hidden state embeddings from the model). Thus, the multimodal attribution system efficiently adapts and deploys across different model types and use cases that involve question and answering environments and/or text and image attribution (e.g., without consuming a large number of computational resources to prepare and reducing GPU requirements, which results in less latency).

In contrast to conventional systems which use answer decomposition and textual entailment, the multimodal attribution system utilizes various functions to filter down a plurality of hidden state embeddings to generate hidden image embeddings and hidden text embeddings and compares the hidden image embeddings and hidden text embeddings to a target phrase (e.g., the answer or part of the answer). In doing so, the multimodal attribution system efficiently determines the highest measures of similarity with the target phrase (e.g., the portions of the digital document that provide the best support to the target phrase) and provides for display in a graphical user interface, an indication of the text attribution and/or an indication of the image attribution. Thus, the methods utilized by the multimodal attribution system reduces computational inefficiencies relative to conventional systems.

Related to the computational accuracy and efficiency improvements of the multimodal attribution system, the multimodal attribution system also improves upon operational flexibility relative to conventional systems. As mentioned above, the multimodal attribution system performs both text attribution and image attribution. In doing so, the multimodal attribution system extends attribution tasks to additional modalities. Moreover, in one or more embodiments, the multimodal attribution system provides versatility in attributing image regions in context of a question answering environment. For instance, as mentioned above, the multimodal attribution system attributes image regions that are indicated in a digital document and that support a selection of a portion of an answer generated in a question answering environment (e.g., the multimodal attribution system). In particular, the multimodal attribution system processes digital documents with a wide variety of image types and is further capable of performing image attribution for a wide variety of image types. For example, the multimodal attribution system bridges a significant gap relative to existing attribution techniques, especially for digital documents containing diverse visual elements such as natural images, charts, infographics, scanned documents, and images with multilingual text.

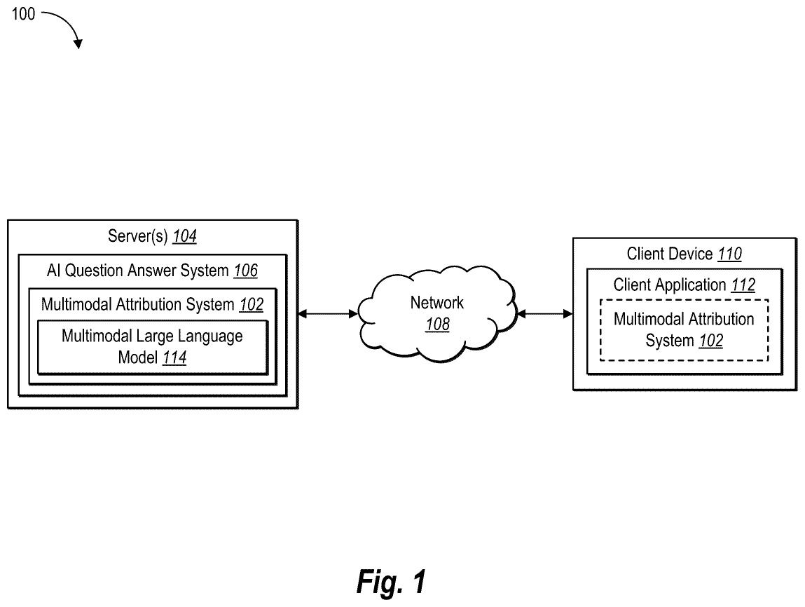

Additional details regarding the multimodal attribution system will now be provided with reference to the figures. For example, FIG. 1 illustrates a schematic diagram of an exemplary system environment 100 in which a multimodal attribution system 102 operates. As illustrated in FIG. 1, the system environment 100 includes server(s) 104, an AI question answer system 106, a network 108, and a client device 110. Additionally, FIG. 1 illustrates that the AI question answer system 106 includes the multimodal attribution system 102 and the multimodal attribution system 102 further includes a multimodal large language model 114. Moreover, the client device 110 includes a client application 112.

Although the system environment 100 of FIG. 1 is depicted as having a particular number of components, the system environment 100 is capable of having a different number of additional or alternative components (e.g., a different number of servers, client devices, or other components in communication with the multimodal attribution system 102 via the network 108). Similarly, although FIG. 1 illustrates a particular arrangement of the server(s) 104, the network 108, and the client device 110, various additional arrangements are possible.

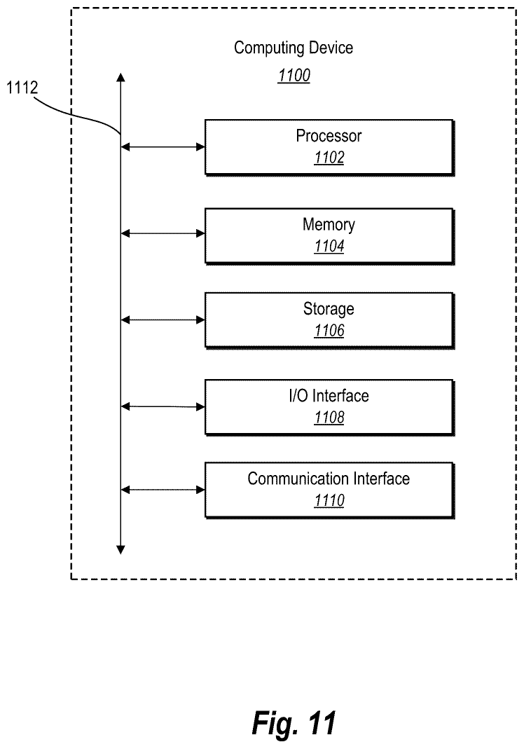

The server(s) 104, the network 108, and the client device 110 are communicatively coupled with each other either directly or indirectly (e.g., through the network 108 discussed in greater detail below in relation to FIG. 11). Moreover, the server(s) 104 and the client device 110 include one or more of a variety of computing devices (including one or more computing devices as discussed in greater detail in relation to FIG. 11).

As mentioned above, the system environment 100 includes the server(s) 104. In one or more embodiments, the server(s) 104 process input for generating an artificial intelligence answer to a prompt relative to a digital document and further process input for generating hidden state embeddings, text attributions, and image attributions. In one or more embodiments, the server(s) 104 comprise a data server. In some implementations, the server(s) 104 comprise a communication server or a web-hosting server.

In one or more embodiments, the client device 110 includes computing devices associated with the one or more user accounts that access digital documents and further submit digital text prompts for the multimodal attribution system 102 to generate an artificial intelligence answer and to further indicate portions within the digital document (e.g., in response to a selection of at least a portion of the artificial intelligence answer). In one or more embodiments, the multimodal attribution system 102 utilizes the multimodal large language model 114 to generate the artificial intelligence answer (e.g., responsive to a prompt relative to a digital document) and further utilizes the multimodal large language model 114 to also generate the text attributions and the image attributions. In one or more embodiments, the multimodal attribution system 102 utilizes a different transformer-based model (e.g., large language model) to generate an artificial intelligence answer and then leverages the multimodal large language model 114 to generate the text attributions and/or image attributions.

In one or more embodiments, the client device 110 includes smartphones, tablets, desktop computers, laptop computers, head-mounted-display devices, or other electronic devices. The client device 110 includes one or more software applications (e.g., the client application 112 includes a digital document editing application) for querying a digital document that includes text and image elements with the AI question answer system 106. In one or more embodiments, the client application 112 includes a software application hosted on the server(s) 104 accessible by the client device 110 through another application, such as a web browser.

To provide an example implementation, in one or more embodiments, the multimodal attribution system 102 on the server(s) 104 supports the multimodal attribution system 102 on the client device 110. For instance, in some cases, the AI question answer system 106 on the server(s) 104 gathers data for the multimodal attribution system 102. In response, the multimodal attribution system 102, via the server(s) 104, provides the information to the client device 110. In other words, the client device 110 obtains (e.g., downloads) the multimodal attribution system 102 from the server(s) 104. Once downloaded, the multimodal attribution system 102 on the client device 110 provides tools for indicating portions of a digital document for text attribution and/or image attribution (e.g., in response to a selection of at least a portion of an answer).

In alternative implementations, the multimodal attribution system 102 includes a web hosting application that allows the client device 110 to interact with content and services hosted on the server(s) 104. To illustrate, in one or more implementations, the client device 110 access a software application supported by the server(s) 104. In response, the multimodal attribution system 102 on the server(s) 104 provides tools for submitting a prompt relative to a digital document.

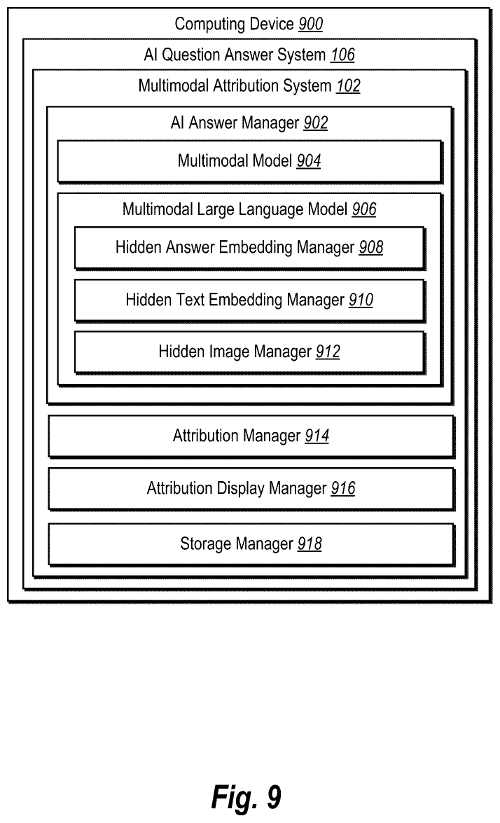

Indeed, in one or more embodiments, the multimodal attribution system 102 is implemented in whole, or in part, by the individual elements of the system environment 100. For instance, although FIG. 1 illustrates the multimodal attribution system 102 implemented or hosted on the server(s) 104, different components of the multimodal attribution system 102 are able to be implemented by a variety of devices within the system environment 100. For example, one or more (or all) components of the multimodal attribution system 102 are implemented by a different computing device or a separate server from the server(s) 104. Indeed, as shown in FIG. 1, the client device 110 includes the multimodal attribution system 102. Example components of the multimodal attribution system 102 will be described below with regard to FIG. 9.

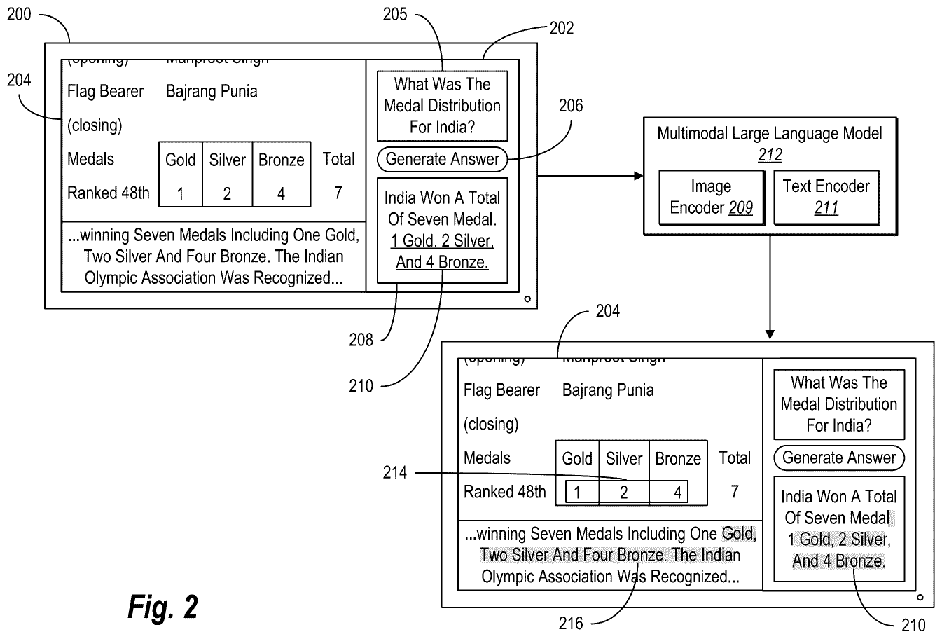

As mentioned above, in certain embodiments, the multimodal attribution system 102 receives a selection of at least a portion of an artificial intelligence generated answer (e.g., in response to a prompt relative to a digital document) and further generates a text attribution and an image attribution (e.g., a bounding box attribution) that indicates portion that provide support to the selection. FIG. 2 illustrates an overview diagram of the multimodal attribution system 102 providing for display an image attribution of an image element within a digital document and a text attribution of a portion of text in the digital document in accordance with one or more embodiments.

As shown, FIG. 2 shows a client device 200 that provides for display a digital document 204 and a prompt panel 202. In one or more embodiments, a digital document refers to a digital file that contains content structured and displayed according to a specific document type. Specifically, the digital document includes written and visual content such as text elements and image elements. To illustrate, the digital document includes PDF documents, DOCX documents, HTML documents, TXT documents, and other documents that support text and image elements.

Moreover, FIG. 2 shows the multimodal attribution system 102 causing the client device 200 to display in tandem with the digital document 204, the prompt panel 202. In one or more embodiments, the prompt panel 202 refers to a portion of the graphical user interface provided in tandem with the digital document for a client device to submit one or more prompts relative to the digital document 204. Specifically, the prompt panel 202 provides options for the client device 200 to summarize the digital document 204, to submit a specific question about a portion of the digital document 204, etc. To illustrate, FIG. 2 shows the client device 200 submitting a prompt relative to the digital document 204 that reads “what was the medal distribution for India?”

As mentioned above, the digital document 204 contains text and image elements. In one or more embodiments, text refers to a component of written content (e.g., text) within the digital document 204. Specifically, text in the digital document 204 includes a paragraph, a sentence, a heading, a word, a character, a list item, a hyperlink, a quotation, and a page of text within the digital document 204.

In one or more embodiments, an image element refers to visual elements within the digital document 204. Specifically, an image element includes pixel(s), a resolution of an image, text assigned to an image element (e.g., text within a digital image), an aspect ratio of a digital image, various image effects applied to a digital image, metadata tags associated with an image, and specific regions/portions of a digital image. To illustrate, an image element includes elements of a natural image (e.g., an image taken of a natural scene), a chart, an infographic, a scanned digital document, and/or an image with multilingual text.

As mentioned, a digital document includes image elements, such as a digital image. In one or more embodiments, a digital image includes various pictorial elements. In particular, the pictorial elements include pixel values that define the spatial and visual aspects of the digital image such as text and image objects. For example, the digital image is a rasterized image which includes a grid of pixels. In particular, the rasterized image includes a fixed resolution as determined by a number of pixels within the digital image. Further, in one or more embodiments, the digital image is a vector image. To illustrate, the digital document contains one or more digital images along with text elements. Further, the digital image includes a variety of formats of an image (JPEG, PNG, GIF, SVG, etc.).

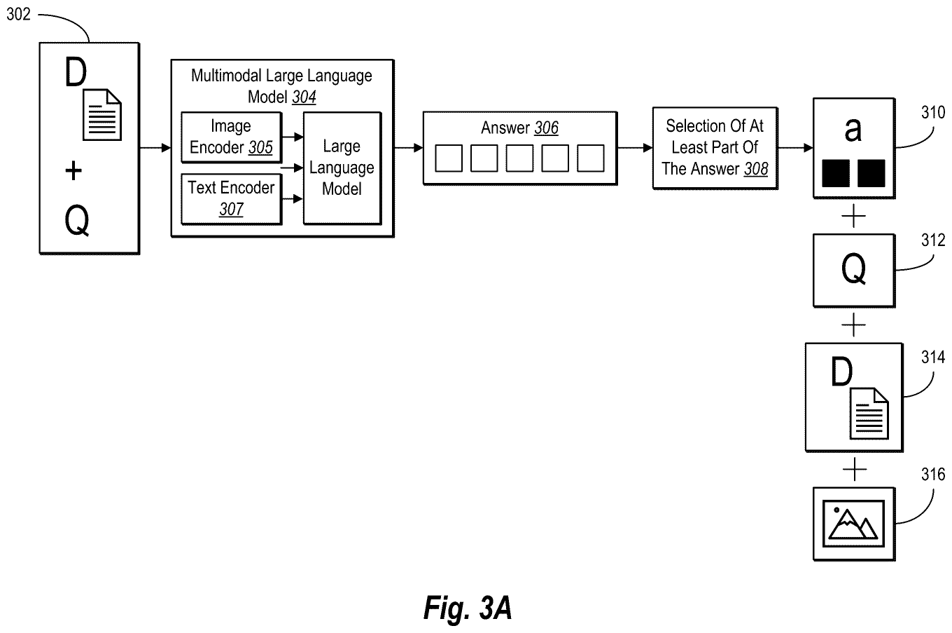

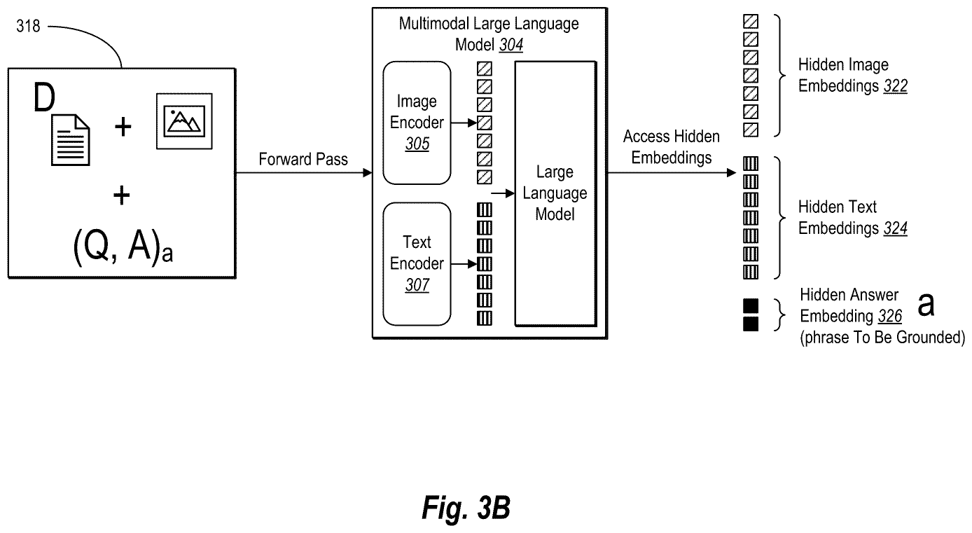

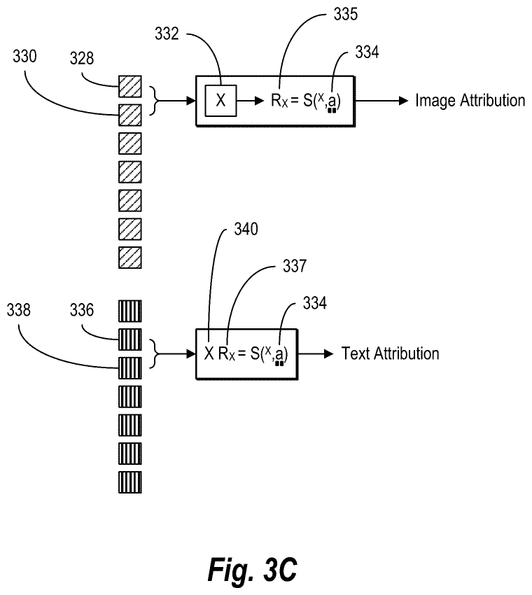

As shown in FIG. 2, the multimodal attribution system 102 receives a prompt 205 relative to the digital document 204 that reads “what was the medal distribution for India?” Furthermore, FIG. 2 shows that in response to a selection of a generate element 206, the multimodal attribution system 102 utilizes one or more artificial intelligence models to generate an answer 208 (e.g., an artificial intelligence answer). Details regarding generating the answer and generating the text/image attribution are given below in the description of FIGS. 3-8.

In one or more embodiments, the prompt 205 refers to a request, question, or instruction to elicit a specific response or action from a model. Specifically, a prompt includes a text input to guide a model to generate a specific response. For example, a prompt includes a client device submitting a question regarding a digital document (e.g., “does the digital document describe how can I renew my license?” “describe the image shown in the digital document?” “In the digital document what is the percentage of homelessness in the age group of 65+?”). In other words, the multimodal attribution system 102 provides an option for a client device to submit a prompt relative to a digital document to guide the multimodal attribution system 102 in generating an answer to the prompt submitted from the client device.

In one or more embodiments, the answer 208 refers to an output or a response to a prompt. Specifically, the multimodal attribution system 102 generates the answer 208 responsive to the prompt 205 relative to a digital document. In other words, the multimodal attribution system 102 grounds a generated answer on sources within a digital document. As shown in FIG. 2, the multimodal attribution system 102 generates the answer 208 responsive to the prompt 205 that reads “India won a total of seven medals. 1 gold, 2 silver, and 4 bronze.”

In one or more embodiments, the multimodal attribution system 102 adds additional context to an answer to more directly respond to a prompt. For instance, for a prompt that reads “what was the medal distribution for India and how does this compare with China and the United States” the multimodal attribution system 102 generates an answer based on sources (e.g., the first digital document and related text) within the digital document and further draws upon additional sources within additional digital documents. In other words, the multimodal attribution system 102 generates an answer where the multimodal attribution system 102 traces the answer back to one or more sources that provide support for the answer.

As mentioned above, the multimodal attribution system 102 grounds a generated answer on sources within the digital document 204. Specifically, a source refers to a text span in the digital document and/or a region of a digital image in the digital document 204. For instance, the multimodal attribution system 102 relies on sources within the digital document 204 to support the answer 208 and to prevent creating answers with hallucinations. As shown in FIG. 2, the answer 208 reads “India won a total of seven medals. 1 gold, 2 silver, and 4 bronze.” The answer 208 originates from sources such as the table graphic shown in the digital document 204 and further originates from text that reads “this was also the most successful games for India with the team winning seven medals including one gold, two silver, and 4 bronze.”

As mentioned above, the answer 208 originates from text. For example, an answer (e.g., an artificial intelligence generated answer) includes a text source, such as a text span within the digital document 204. In one or more embodiments, a text span refers to a specific portion of text in the digital document 204 that is extracted by the multimodal attribution system 102 and used to generate an answer to a prompt. For example, the text span refers to a sentence, a paragraph, or a phrase within the digital document 204. Specifically, the text span is a passage of text within the digital document 204 that is contextually relevant to the prompt 205 submitted by the client device and the text span either directly or indirectly responds to the prompt.

Further, as also mentioned above, the multimodal attribution system 102 generates an answer that is grounded by an image source. In one or more embodiments, the multimodal attribution system 102 determines an image region referred to by the prompt 205 that supports the answer 208 generated by the multimodal attribution system 102. For example, the image region includes an entire frame of a digital image, a single image patch, multiple image patches, a specific pixel or set of pixels within a digital image, or portions of image patches. To illustrate, FIG. 2 shows the image source as a table that (visually) shows the number of gold medals, silver medals, and bronze medals won by India.

FIG. 2 shows the multimodal attribution system 102 receiving a selection 210 of the answer 208. Specifically, FIG. 2 shows the selection 210 including a portion of the answer, which reads “1 gold, 2 silver, and 4 bronze.” In other words, the client device 200 performs the selection 210 to indicate to the multimodal attribution system 102 a desire to know where that specific part of the answer 208 is grounded within the digital document 204.

As shown in FIG. 2, the multimodal attribution system 102 passes data to a multimodal large language model 212 that includes an image encoder 209 and a text encoder 211. Specifically, the multimodal attribution system 102 passes a combined input that includes the digital document 204, the prompt 205, and the answer 208 (e.g., specifically, the selection 210 of the answer 208) to the multimodal large language model 212 as a sequence of data (e.g., the multimodal attribution system 102 breaks down image elements into a sequence of image tokens (based on image patches) and breaks down text into a sequence of text tokens). Specific details of the multimodal attribution system 102 utilizing the multimodal large language model 212 is discussed below in the description of FIGS. 3-8.

As further shown in FIG. 2, the multimodal attribution system 102 utilizes the multimodal large language model 212 to process the combined input and further generates an image attribution 214 and a text attribution 216. In one or more embodiments, the image attribution 214 refers to an indication of an image element in the digital document 204 being attributed to the selection 210 of at least a portion of the answer 208. Further, the image attribution 214 provides support for the at least a portion of the answer 208 that is selected. For instance, the image attribution 214 includes a bounding box attribution that surrounds a relevant portion/region of a digital image. In FIG. 2, the image attribution 214 includes an outlined indication around the table for gold, silver, and bronze medals.

In one or more embodiments, the text attribution 216 refers to an indication of text in the digital document 204 (e.g., a span of text in the digital document 204) being attributed to the selection 210 of at least a portion of the answer 208. Further, the text attribution 216 provides support for the selection 210 of the at least a portion of the answer 208. In FIG. 2, the text attribution 216 includes a highlighted indication on the text in the digital document that reads “gold, two silver and four bronze.”

Additional examples of prompts and artificial intelligence generated answer (e.g., and their sources within the digital document) are provided herein. For instance, for a prompt such as “does the digital document describe how can I renew my license?” the multimodal attribution system 102 generates an answer such as “the digital document states that the license can be renewed on mutual consent with the licensor for a further period of 11 months with a 5% escalation.” Further, for a prompt such as “describe the image shown in the digital document?” the multimodal attribution system 102 generates an answer such as “the image is of a check from the state bank of New York. It is made out to ‘John Smith’ for the amount of twenty-five thousand dollars. The check is dated Apr. 5, 2019, and is signed by ‘Sara Johnson.’ The check number is 230270.”

To further illustrate, for a text prompt “in the digital document what is the percentage of homelessness in the age group of 65+?” the multimodal attribution system 102 generates an answer that reads “3% of the homeless in Philadelphia are in the age group 65+” and determines a source for the answer in the digital document as a graphical pie chart that reads “homelessness by age in Philadelphia.” In other words, sources for an answer includes both text and image elements.

To illustrate, the multimodal attribution system 102 receives a prompt of “what is a Shepards pie?” Further, the digital document contains content that reads “Shepards pie is a traditional dish originating from the United Kingdom. Shepards pie is a savory dish that is filled with ground meat, topped with a layer of mashed potatoes, and is baked until golden and crispy. For the most part, people use minced lamb in the Shepards pie.”

Moreover, the multimodal attribution system 102 identifies a text span relevant to the prompt such as “Shepards pie is a savory pie dish that is filled with ground meat, topped with a layer of mashed potatoes, and is baked until golden and crispy.” In response, the multimodal attribution system generates an answer of “A pie filled with ground meat, topped with mashed potatoes, and baked until golden and crispy.”

As mentioned above, the multimodal attribution system 102 generates an artificial intelligence answer to a prompt and further receives a selection of at least part of the answer. FIG. 3A illustrates the multimodal attribution system 102 generating an answer and further preparing a combined input for performing an attribution task in accordance with one or more embodiments. For example, FIG. 3A shows the multimodal attribution system 102 initially receiving a digital document (e.g., D) and a prompt (e.g., Q), where the prompt is a question relative to the digital document. Specifically, FIG. 3A shows the multimodal attribution system 102 processing a prompt relative to a digital document 302 utilizing an artificial intelligence model.

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in one or more embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In one or more embodiments, a neural network includes a combination of neural networks or neural network components.

In one or more embodiments, a large language model includes or refers to one or more neural networks (e.g., artificial intelligence networks) capable of processing natural language text to generate outputs that range from predictive outputs, analyses, or combinations of data within stored content items. In particular, a large language model can include parameters trained (e.g., via deep learning) on large amounts of data to learn patterns and rules of language for summarizing and/or generating digital content. Examples of large language model include Adobe Assistant AI, and GPT-based models. For example, the multimodal attribution system 102 utilizes a language model (e.g., a natural language model, a large language model, or a transformer-based model) as described in patent application Ser. No. 18/420,399, titled WEAKLY-SUPERVISED REFERRING EXPRESSION SEGMENTATION, filed on Jan. 23, 2024, which is fully incorporated by reference herein.

As shown in FIG. 3A, the multimodal attribution system 102 utilizes a multimodal large language model 304 as the artificial intelligence model to generate an answer 306. As shown in FIG. 3A, the multimodal attribution system 102 processes the prompt relative to the digital document 302 and generates the answer 306, which is responsive to the prompt relative to the digital document 302. As alluded to above, the multimodal attribution system 102 utilizes the same model (e.g., the multimodal large language model 304) to generate the answer 306 and to perform attribution tasks. Although FIG. 3A shows the multimodal attribution system 102 utilizing the multimodal large language model 304 to generate the answer 306, in one or more embodiments, the multimodal attribution system 102 utilizes a first artificial intelligence model to generate the answer 306 and a second artificial intelligence model to perform the attribution task.

FIG. 3A further shows a selection 308 of at least part of the answer. In one or more embodiments, the multimodal attribution system 102 receives a selection of at least a portion of the answer by a client device, where the portion includes the entire answer or a subset of the answer 306. To illustrate, for an answer “Shepards pie is a savory pie dish that is filled with ground meat, topped with a layer of mashed potatoes, and is baked until golden and crispy,” the multimodal attribution system 102 receives a selection of “mashed potatoes.” For instance, the multimodal attribution system 102 provides an option for a client device to select at least a portion of the answer to further identify one or more sources within the digital document that results in the generated portion of the answer (e.g., the client device wants to know what portion of the digital document refers to mashed potatoes, as text referring to mashed potatoes were used to generate the answer).

Furthermore, FIG. 3A shows the multimodal attribution system 102 utilizing the selection 308 of at least part of the answer as an anchor 310. For example, the anchor 310 refers to a reference point within the answer 306 that the multimodal attribution system 102 uses to further identify sources in the digital document that are specifically related to the selection of the at least a portion of the answer. Specifically, the multimodal attribution system 102 identifies hidden state embeddings linked to tokens for the anchor 310 (e.g., tokens for the selected portion of the answer 306). In other words, the multimodal attribution system 102 leverages the anchor 310 to filter down a plurality of hidden state embeddings to identify the hidden state embeddings that support the selection of the at least portion of the answer (e.g., what tokens in the digital document lend support to “mashed potatoes”).

As further shown in FIG. 3A, the multimodal attribution system 102 combines the anchor 310 (e.g., the selection 308 of at least part of the answer 306), a prompt 312, a digital document 314, (e.g., the prompt relative to the digital document 314) and an image 316 (e.g., an image element in the digital document 314). Specifically, the multimodal attribution system 102 combines the data to perform a forward pass through an artificial intelligence model described below in FIG. 3B.

As mentioned above, the multimodal attribution system 102 performs attribution tasks with increased accuracy and efficiency (e.g., relative to conventional systems) by accessing hidden state embeddings from intermediate layers of a multimodal large language model. FIG. 3B shows an example diagram of the multimodal attribution system 102 performing a forward pass through a multimodal large language model in accordance with one or more embodiments.

FIG. 3B shows the multimodal attribution system 102 generating a combined input 318. For example, the combined input 318 includes the digital document 314, the prompt 312, the answer 306 as the anchor 310, and the image 316. Specifically, the multimodal attribution system 102 concatenates the digital document 314, the prompt 312, the answer 306 as the anchor 310, and the image 316. As shown in FIG. 3B, the multimodal attribution system 102 passes the combined input 318 through layers of a multimodal large language model 304.

In one or more embodiments, the multimodal attribution system 102 utilizes the multimodal large language model 304 to generate a text attribution and/or an image attribution responsive to a prompt relative to a digital document. Specifically, the multimodal large language model 304 includes an artificial intelligence model to process and understand inputs from different data modalities. For instance, the multimodal large language model 304 is a language-based transformer model (e.g., a model with one or more transformer blocks that include attention layers, such as cross attention and self-attention layers, and one or more modulation layers) that the multimodal attribution system 102 utilizes to process tokens. For example, the multimodal attribution system 102 utilizes the multimodal large language model 304 to extract salient features from image inputs using a vision encoder, coupled with a large language model that processes textual data. To illustrate, the integration of the vision encoder with a large language model enables the multimodal attribution system 102 to perform complex tasks such as visual question answering, image captioning, and cross-modal reasoning.

In other words, the multimodal attribution system 102 unifies a latent space (e.g., fuses information) for a diverse set of modes (e.g., text and image) to further determine a text attribution and an image attribution responsive to a prompt relative to a digital document, where the image attribution and the text attribution indicate portions of the digital document that provide support for an answer or a portion of an answer. For example, the multimodal large language model 304 includes a text encoder 307 and an image encoder 305 to encode different modalities from a digital document and further transforms image embeddings into image tokens.

In one or more embodiments, the multimodal attribution system 102 accesses the multimodal large language model 304 with pre-training on large-scale datasets encompassing both textual and visual information, followed by fine-tuning for specific downstream tasks (e.g., multi-modal comprehension and generation). However, the multimodal attribution system 102 at run-time (e.g. inference time) does not require additional fine-tuning/training to perform multimodal attribution tasks for artificial intelligence generated answers.

In some embodiments, the multimodal attribution system 102 uses a recurrent neural network as the multimodal large language model 304. Specifically, a recurrent neural network refers to an artificial intelligence model for processing sequential data (e.g., image patches and text). For instance, a recurrent neural network includes connections that loop back on themselves, allowing the network to retain information from previous nodes/steps. Further, the multimodal attribution system 102 utilizes a recurrent neural network to understand context surrounding a text span and/or image span and how specific tokens are related to downstream or upstream tokens.

In one or more embodiments, the multimodal attribution system 102 utilizes the text encoder 307 to process a text prompt. In particular, the text encoder 307 includes a component of a neural network to transform textual data (e.g., the text prompt) into a numerical representation. For instance, the multimodal attribution system 102 utilizes the text encoder 307 to transform the text prompt into a text encoding (e.g., text tokens). Further, the multimodal attribution system 102 utilizes the text encoder 307 in a variety of ways. For instance, the multimodal attribution system 102 utilizes the text encoder 307 to i) determine the frequency of individual words in the text (e.g., each word becomes a feature vector), ii) determines a weight for each word within the text, the digital document, and the answer (e.g., or at least a portion of the answer) to generate a text vector that captures the importance of words within the text, iii) generates low-dimensional text vectors in a continuous vector space that represents words within the text, and/or iv) generates contextualized text vectors by determining semantic relationships between words within the text.

In one or more embodiments, the multimodal attribution system 102 generates text tokens from the text. For example, the multimodal attribution system 102 utilizes the text encoder 307 to generate a representation of the text for a machine learning task. Specifically, a single text token refers to a word, a sub-word, or a character (e.g., “the,” “on,” “cat,” “t,” “showcasing,” “show,” “casing,” etc.). Furthermore, the multimodal attribution system 102 generates tokens representing special meaning or purposes such as the beginning or an end of a sentence.

In one or more embodiments, the image encoder 305 is a neural network (or one or more layers of a neural network) that extract features relating to digital images. In some cases, the image encoder 305 refers to a neural network that both extracts and encodes features from a digital image. For example, the image encoder 305 can include a particular number of layers including one or more fully connected and/or partially connected layers of neurons that extract image patches from the digital image and encode localized features of the digital image. To illustrate, in one or more embodiments, the multimodal attribution system 102 generates an image embedding that represents a complete frame of a digital image.

In one or more embodiments, the multimodal attribution system 102 utilizes the image encoder 305 to generate image embeddings. In one or more embodiments, the image embeddings include a numerical representation (e.g., a vector) of a digital image. For instance, the image embeddings capture features and properties of the digital image within the digital document 314. To illustrate, the image embeddings include semantic information such as the presence of objects, shapes, and spatial relationships.

In one or more embodiments, the multimodal attribution system transforms the image embeddings into visual tokens by utilizing the image encoder 305. For example, the multimodal attribution system 102 utilizes a tokenization model to patchify the image embeddings. Specifically, a tokenization model converts the image embedding into smaller patches or grids that are treated as individual tokens for further processing (e.g., adding noise and then denoising). For instance, the multimodal attribution system 102 utilizes patchification to handle high-dimensional image data efficiently. To illustrate, the multimodal attribution system 102 flattens each patch of the image embedding (e.g., into a single dimension vector), converts the flattened patch into a lower-dimensional representation, and maps the flattened lower-dimensional patch into a fixed-length feature vector. Accordingly, the multimodal attribution system 102 treats the flattened fixed-length feature vector as a visual token and utilizes the multimodal large language model 304 to process the visual tokens.

For instance, a visual token represents an image patch in a digital image. In one or more embodiments, the multimodal attribution system 102 selects a set of image patches from a digital image. In particular, the multimodal attribution system 102 generates the set of image patches by sub-dividing a digital image into smaller regions. For instance, the multimodal attribution system 102 sub-divides the digital image into patches based on a predetermined resolution (e.g., 256×256), where each patch represents localized regions within the digital image. In one or more embodiments, an image patch of the set of image patches does not share any pixel values with other image patches. In one or more embodiments, an image patch of the set of image patches overlaps with pixel values of an adjacent image patch. Accordingly, in one or more embodiments, the multimodal attribution system 102 sub-divides a digital image into image patches where some of the image patches do not overlap with pixel values of other image patches and some of the image patches do overlap with pixel values of other image patches.

As described above, the multimodal attribution system 102 utilizes the image encoder 305 and the text encoder 307 to generate tokens (e.g., encodings or vector representations) of the combined input 318 and further performs a forward pass through the multimodal large language model 304 with the combined input 318. To reiterate, the multimodal attribution system 102 utilizes the multimodal large language model 304 to process sequential data, such as a string of image tokens and/or a string of text tokens. Specifically, the multimodal attribution system 102 utilizes the multimodal large language model 304 because of its ability to understand/preserve semantic and contextual understanding between upstream and downstream tokens in a sequence of data (e.g., the combined input 318 broken down into a sequence of tokens).

In one or more embodiments, a forward pass through a neural network (e.g., the multimodal large language model 304) refers to a process of feeding input data through layers of the neural network to compute an output. Specifically, the multimodal attribution system 102 performs a forward pass to pass input data through each layer (e.g., including intermediate layers) and applies various mathematical operations at each layer to extract features and generate an output. In other words, the multimodal attribution system 102 passes as input a combination of the digital document (e.g., text and image elements), the prompt relative to the digital document, and a selection of the at least a portion of the answer for the multimodal large language model 304 to simulate generating tokens of the answer.

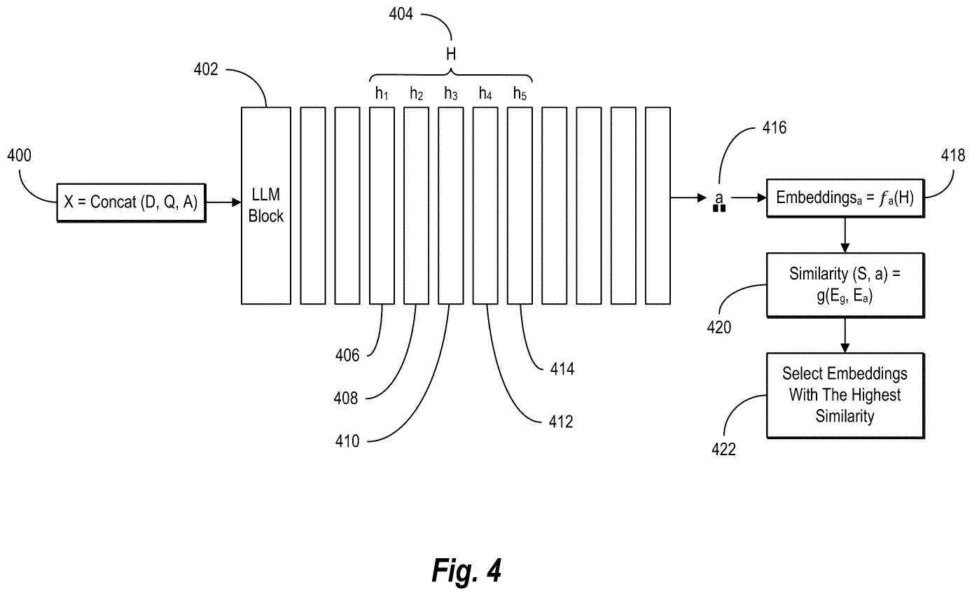

As shown in FIG. 3B, the multimodal attribution system 102 accesses hidden state embeddings from the multimodal large language model 304. Specifically, the multimodal attribution system 102 accesses hidden state embeddings from intermediate layers of the multimodal large language model 304, which is discussed in more detail below in FIGS. 4-6. As shown in FIG. 3B, the multimodal attribution system 102 accesses hidden image embeddings 322, hidden text embeddings 324, and a hidden answer embedding 326 (e.g., the phrase to be grounded from the answer).

As mentioned above, in one or more embodiments, the multimodal attribution system 102 first generates the answer and then generates the text attribution and the image attribution by performing a forward pass. In one or more embodiments, the multimodal attribution system 102 simultaneously generates the answer and the text attribution/image attribution. To illustrate, in one or more embodiments, the multimodal attribution system 102 accesses a first multimodal large language model (e.g., Adobe Acrobat AI Assistant) to generate an answer for a prompt, and then utilizes a second multimodal large language model (e.g., the multimodal large language model 304) to perform the text and/or image attribution for the grounded answer (e.g., the selected portion of the answer generated by the first multimodal large language model)

To further illustrate, in one or more embodiments, the multimodal attribution system 102 accesses the multimodal large language model 304 to generate the answer for a prompt and as the multimodal large language model 304 is generating the answer, the multimodal attribution system 102 further accesses hidden state embeddings from the intermediate layers to simultaneously generate the image and/or text attributions (e.g., the multimodal attribution system 102 generates the text attribution and the image attribution in parallel with the answer and provides for display the attribution(s) in response to a selection of at least a portion of the artificial intelligence response).

FIG. 3C illustrates an example diagram of the multimodal attribution system 102 determining an image attribution and a text attribution from the hidden state embeddings in accordance with one or more embodiments. As discussed above in FIG. 3B, the multimodal attribution system 102 accesses the hidden state embeddings from intermediate layers of the multimodal large language model 304. From the hidden state embeddings, the multimodal attribution system 102 generates hidden image embeddings and hidden text embeddings. Specifically, the multimodal attribution system 102 generates a hidden text embedding for a text span (e.g., a portion of text in the digital document) and generates a hidden image embedding for an image region (e.g., a region of an image in the digital image).

As shown in FIG. 3C, the multimodal attribution system 102 identifies an image span of the hidden state embeddings and combines (e.g., averages) hidden state embeddings for the identified image span. Specifically, the multimodal attribution system 102 combines a first hidden state embedding 328 and a second hidden state embedding 330 to generate a first hidden image embedding 332. Furthermore, FIG. 3C shows the multimodal attribution system 102 determining a measure of similarity 335 for the first hidden image embedding 332. For instance, the multimodal attribution system 102 compares the first hidden text embedding 332 with a hidden answer embedding 334 (e.g., the anchor, i.e., hidden state embeddings for the selected portion of the answer) to determine the measure of similarity 335.

Similarly, as shown, the multimodal attribution system 102 identifies a text span of the hidden state embeddings and combines (e.g., averages) hidden state embeddings for the identified text span. Specifically, the multimodal attribution system 102 combines a third hidden state embedding 336 with a fourth hidden state embedding 338 to generate a first hidden text embedding 340. For instance, the multimodal attribution system 102 compares the first hidden text embedding 340 with the hidden answer embedding 334 to determine a measure of similarity 337.

In one or more embodiments, the multimodal attribution system 102 compares the hidden answer embedding 334 (e.g., the average of the hidden state embeddings for the selection of at least a portion of the answer) with a hidden text embedding and a hidden image embedding. For each comparison, the multimodal attribution system 102 generates a measure of similarity. In particular, a measure of similarity refers to a mathematical or statistical metric to quantify how related the hidden state embeddings are to each other.

To illustrate, in one or more embodiments, the multimodal attribution system 102 utilizes cosine similarity to measure to cosine of the angle between two hidden state embeddings in a multidimensional latent space. For instance, for a first text span, the multimodal attribution system 102 compares a first hidden text embedding with the hidden answer embedding to generate a first measure of similarity. Further, for a second text span, the multimodal attribution system compares a second hidden text embedding with the hidden answer embedding to generate a second measure of similarity. If the first measure of similarity is greater than the second measure of similarity, this indicates that the first text span is more similar to the selection of the portion of the answer (e.g., for anchor purposes). Thus, the multimodal attribution system 102 identifies an image attribution and a text attribution based on determined measures of similarity. For instance, the multimodal attribution system 102 takes the highest measures of similarity and uses them as the attributions for a selected portion of an answer.

As mentioned above, the multimodal attribution system 102 accesses hidden state embeddings from intermediate layers of a multimodal large language model. For example, FIG. 4 shows the multimodal attribution system 102 processing a combined input 400. Specifically, the combined input 400 includes a combination (e.g., concatenation) of a digital document, a prompt relative to the digital document, and an answer (e.g., a selection of at least a portion of the answer). For instance, FIG. 4 shows the multimodal attribution system 102 processing the combined input 400 with a multimodal large language model.

In one or more embodiments, the multimodal large language model includes a plurality of layers. For instance, at each layer of the multimodal large language model, the multimodal attribution system 102 generates an embedding or a vector representation of data/information from a previous layer. For example, for a first layer of the multimodal large language model, the multimodal attribution system 102 generates an embedding/vector representation of a concatenation of the digital document, the prompt, and the answer generated by the multimodal attribution system 102 (e.g., at least a portion of the answer). Furthermore, in one or more embodiments, the middle layers of the plurality of layers of the multimodal large language model refers to intermediate layers. For instance, for a multimodal large language model that includes 30 layers, the intermediate layers would be from layers 10-20.

As mentioned above and as shown in FIG. 4, the multimodal large language model includes a plurality of layers, where each layer is a large language model block 402 (e.g., LLM block). Furthermore, FIG. 4 shows intermediate layers 404 that includes a first intermediate layer 406 (h1), a second intermediate layer 408 (h2), a third intermediate layer 410 (h3), a fourth intermediate layer 412 (h4), and a fifth intermediate layer 414 (h5). In one or more embodiments, the multimodal attribution system 102 accesses hidden state embeddings from the intermediate layers 404.

In one or more embodiments, the multimodal attribution system utilizes the multimodal large language model to process the tokens and at the intermediate layers, the multimodal attribution system 102 generates hidden state embeddings. Specifically, hidden state embeddings refer to high-dimensional vector representations of intermediate computational stages within a neural network architecture (e.g., a multimodal large language model). For example, the hidden state embeddings encapsulate internal representations of the processed information and combines features extracted from both textual and visual inputs (e.g., text and image elements in the digital document). In one or more embodiments, the hidden state embeddings (e.g., hidden states) generated in the intermediate layers of the multimodal large language model serve as a unified semantic space where information from different modalities converge.

For instance, the multimodal attribution system 102 generates the hidden state embeddings through a series of transformations applied to input data, where the series of transformations include incorporating attention mechanisms (e.g., an attention mechanism includes a sequence of tokens with weighted sums of all their representations. Specifically, attention mechanisms include query, key, and value tokens where query indicates a purpose of what the model should pay attention to, key indicates a type of information that a token represents, and value indicates information of a specific token) and non-linear activations (e.g., functions applied to an output layer that allow a model to capture and model complex patterns and relationships in the data). Furthermore, the hidden state embeddings capture complex relationships between words, phrases, image elements, and their contextual associations. Accordingly, the multimodal attribution system 102 leverages the hidden state embeddings to perform cross-modal reasoning, as the hidden state embeddings facilitate the transfer of information between the language processing components and visual understanding.

As shown in FIG. 4, the multimodal attribution system 102 identifies an anchor 416. Specifically, the anchor 416 includes a selected portion of the generated answer and the multimodal attribution system 102 utilizes the anchor 416 to identify a subset of hidden state embeddings from the plurality of hidden state embeddings (e.g., of the intermediate layers 404). In particular, the multimodal attribution system 102 leverages the anchor 416 to filter down a plurality of hidden state embeddings by first generating a hidden answer embedding.

As mentioned above, the multimodal attribution system 102 performs a forward pass over the multimodal large language model to simulate the generation of the answer, in doing so, the multimodal attribution system 102 obtains the tokens of the answer (e.g., the artificial intelligence response to the prompt), and further identifies the hidden state embeddings that represent the answer (e.g., hidden state embeddings that correspond with the answer tokens). In other words, the multimodal attribution system 102 utilizes a function to extract and process relevant embeddings (e.g., from the intermediate layers 404) for a selection of at least a portion of the answer. Moreover, the multimodal attribution system 102 averages (e.g., combines) an extracted subset of hidden state embeddings that are relevant to the selection of at least a portion of the answer to generate a hidden answer embedding. In other words, the multimodal attribution system 102 combines each token of a selection of at least a portion of an answer to create the answer hidden state embedding.

As shown, FIG. 4 shows an act 418 of determining embeddingsₐ (e.g., the hidden answer embedding) as utilizing a filtering function (ƒ) for the anchor 416 (a) at the intermediate layers 404. Specifically, for the answer of “a pie filled with ground meat, topped with mashed potatoes, and baked until golden and crispy,” the multimodal attribution system 102 utilizes a filtering function to identify/access hidden states (e.g., hidden state embeddings) for each token in the answer at every layer (e.g., every intermediate layer).

For instance, as part of the architecture of the multimodal large language model, the multimodal attribution system 102 incorporates a hidden state function for each output token (e.g., each token in an output answer), where the hidden state function outputs hidden states (e.g., hidden state embeddings) for each generated token of an answer. In other words, for instances where the multimodal attribution system 102 utilizes the same model for generating an artificial intelligence answer and performing attribution tasks, the multimodal attribution system 102 accesses the hidden state embeddings simultaneously with generating the answer. Moreover, for instances where the multimodal attribution system 102 utilizes a different model for generating an artificial intelligence answer and for performing text/image attribution, the multimodal attribution system 102 accesses the hidden state embeddings by performing a forward pass through the multimodal large language model.

Furthermore, FIG. 4 shows the multimodal attribution system 102 determining a measure of similarity 420 as comparing hidden state embeddings (e.g., for text or image elements) with the hidden answer embedding. Moreover, FIG. 4 shows the multimodal attribution system 102 performing an act 422 of selecting embeddings (e.g., a hidden text embedding and/or a hidden image embedding) with the highest measure of similarity with the hidden answer embedding. In other words, the multimodal attribution system 102 selects a text span that corresponds to a hidden text embedding with the highest measure of similarity with the hidden answer embedding (e.g., the anchor 416) and/or selects an image region that corresponds to a hidden image embedding with the highest measure of similarity with the hidden answer embedding.

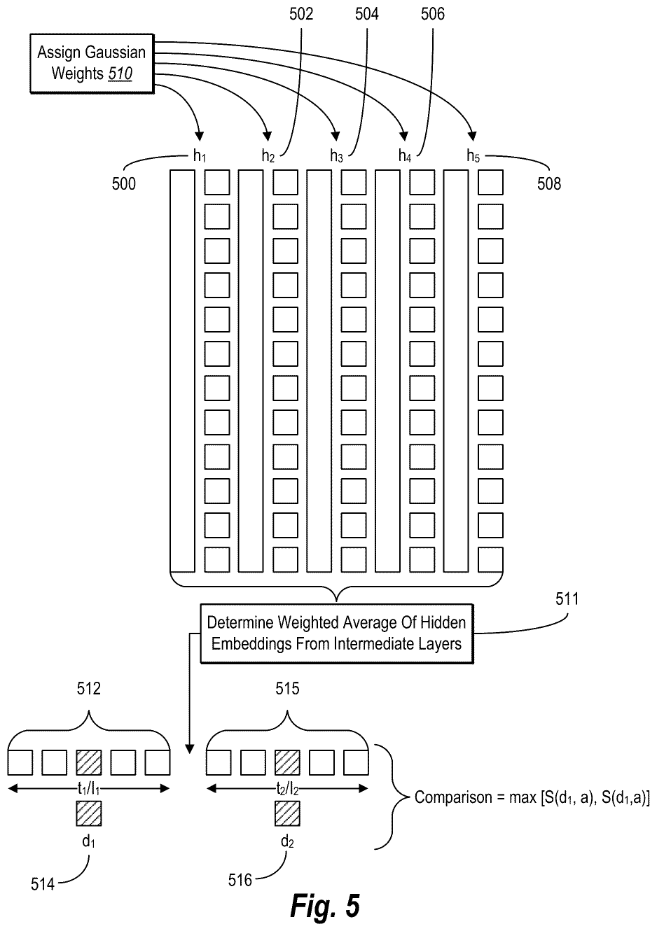

FIG. 5 provides additional details of the multimodal attribution system 102 accessing hidden state embeddings from intermediate layers of the multimodal large language model in accordance with one or more embodiments. For example, FIG. 5 shows a first intermediate layer 500, a second intermediate layer 502, a third intermediate layer 504, a fourth intermediate layer 506, and a fifth intermediate layer 508. Specifically, each of the intermediate layers 500-508 include corresponding hidden state embeddings (e.g., hidden state embeddings generated by a specific intermediate layer).

For instance, the multimodal attribution system 102 processes a representation of the combined input (e.g., the digital document, prompt, and an anchor) at the first intermediate layer 500 (e.g., after passing through a plurality of previous layers) to generate a first set of hidden state embeddings, processes the first set of hidden state embeddings at the second intermediate layer 502 to generate a second set of hidden state embeddings and so forth. For example, the hidden state embeddings at each of the intermediate layers represent a plurality of hidden state embeddings.

FIG. 5 further shows the multimodal attribution system 102 assigning gaussian weights at each of the intermediate layers 500-508. Specifically, the multimodal attribution system 102 assigns the highest gaussian weight 510 to the most intermediate layer (e.g., for a multimodal large language model with 30 layers, the intermediate layers are layers 10-20 and the most intermediate layer is layer 15). In one or more embodiments, the multimodal attribution system 102 assigns the highest gaussian weight 510 to the third intermediate layer 504 shown in FIG. 5. Thus, the hidden state embeddings generated by the third intermediate layer 504 include a representation with a greater weight than hidden state embeddings generated at other intermediate layers.

Moreover, FIG. 5 shows the multimodal attribution system 102 performing an act 511 of determining weighted averages of hidden state embeddings from the intermediate layers 500-508. Specifically, the act 511 includes the multimodal attribution system 102 identifying hidden state embeddings for a specific text span (e.g., “Shepards pie is a traditional dish originating from the United Kingdom. Shepards pie is a savory dish that is filled with ground meat, topped with a layer of mashed potatoes, and is baked until golden and crispy. For the most part, people use minced lamb in the Shepards pie”) and determining the weighted average of the hidden state embeddings (e.g., based on the assigned gaussian weight). For instance, the multimodal attribution system 102 incorporates a hidden state function for each token of a text span, where the hidden state function outputs hidden states (e.g., hidden state embeddings) for the text span (e.g., filters down a plurality of hidden state embeddings to a subset of hidden state embeddings related to the identified text span).

As shown in FIG. 5, the multimodal attribution system 102 generates for a first subset of hidden state embeddings 512 (e.g., the first subset of hidden state embeddings 512 corresponding to a text span in the digital document or an image region in the digital document) a first hidden text/image embedding 514 (e.g., a hidden text embedding or a hidden image embedding). In particular, the multimodal attribution system 102 averages each of the hidden state embeddings of the first subset of hidden state embeddings 512 to generate the first hidden text/image embedding 514. Furthermore, FIG. 5 shows the multimodal attribution system 102 generating for a second subset of hidden state embeddings 515 a second hidden text/image embedding 516.

In one or more embodiments, the multimodal attribution system 102 further utilizes a function (e.g., a first function) to extract and process embeddings for text in the digital document. Specifically, for a first text span, the multimodal attribution system 102 averages the hidden state embeddings for the first text span to generate a first hidden text embedding. Likewise, for a second text span, the multimodal attribution system 102 identifies the relevant hidden state embeddings (e.g., with a hidden state function) and averages the hidden state embeddings for the second text span to generate a second hidden text embedding.

In one or more embodiments, the multimodal attribution system 102 further utilizes a function (e.g., a second function) to extract and process embeddings for image regions in a digital document. Specifically, for a first image region (e.g., one or more image patches), the multimodal attribution system 102 averages the hidden state embeddings for the first image region to generate a first hidden image embedding, and so forth for additional image regions. For example, the multimodal attribution system 102 incorporates a hidden state function for each visual token and the multimodal attribution system 102 outputs the hidden state embeddings (e.g., hidden states) for each visual token of a relevant image region (e.g., one or more image patches of a digital image or portions of image patches).

Furthermore, FIG. 5 shows the multimodal attribution system 102 performing a comparison of the first hidden text/image embedding 514 with the hidden answer embedding, and a comparison of the second hidden text/image embedding 516 with the hidden answer embedding. In doing so, the multimodal attribution system 102 generates a first measure of similarity for the first hidden text/image embedding 514 and a second measure of similarity for the second hidden text/image embedding 516.

In one or more embodiments, based on the measures of similarity, the multimodal attribution system 102 determines a text and/or image attribution (e.g., the text/image attribution is the text span/image region with the maximum cosine similarity with the selection of at least a portion of the answer). In other words, the multimodal attribution system 102 takes the anchor (e.g., the selection of at least a portion of the answer as the grounded phrase) to assign similarities to all tokens (e.g., text tokens) to generate candidate text spans. For instance, the multimodal attribution system 102 uses a sliding token window (e.g., the multimodal attribution system 102 starts with the anchor token in the digital document and progressively slides the sequence of tokens included in a window and compares each token window with the anchor token) starting from the anchor token(s) and a token window with the highest similarity gives the candidate phrases for the text attribution.

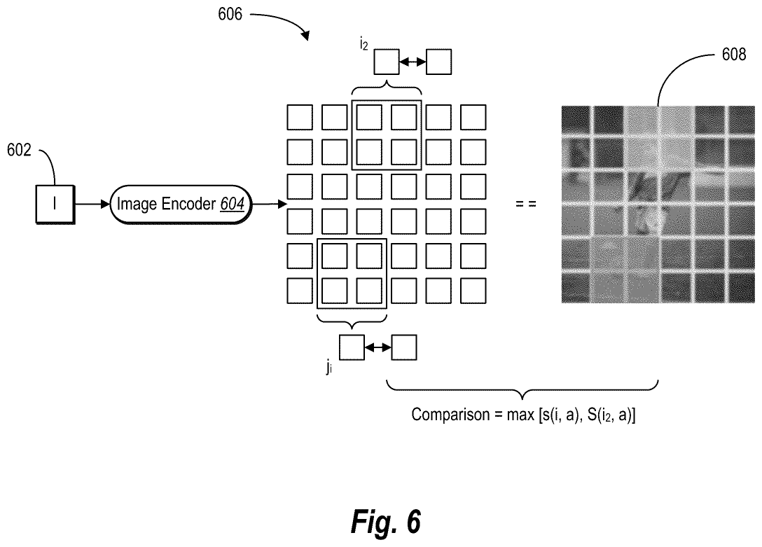

FIG. 6 illustrates an example diagram of the multimodal attribution system 102 generating hidden image embeddings in accordance with one or more embodiments. For example, FIG. 6 shows the multimodal attribution system 102 utilizing an image encoder 604 of a multimodal large language model to process image elements 602 of a digital document. Specifically, FIG. 6 shows the multimodal attribution system 102 generating a plurality of image patches 606. For instance, the multimodal attribution system 102 breaks down a digital image in the digital document to the plurality of image patches 606.

To illustrate, the multimodal attribution system 102 utilizes the image encoder 604 to break down a digital image into thirty-five image patches by height and thirty-five image patches by width. In particular, each image patch includes a 14×14 pixel width. Furthermore, the multimodal attribution system 102 computes an average of one or more image patches in a two-dimensional location (e.g., image patch(s) covering a soccer ball or image patch(s) covering a child's head). In one or more embodiments, the multimodal attribution system 102 utilizes different variations of breaking down a digital image into a number of image patches, where the pixel dimensions of each image patch vary.

In one or more embodiments, the multimodal attribution system 102 brute forces over all possible image patches (e.g., bounding boxes) spanning a digital image to determine image attribution. Specifically, the multimodal attribution system 102 utilizes a 2×2, a 2×1, 3×2, a 4×2, etc. to cover all iterations of image patches (e.g., bounding boxes spanning a digital image). In other words, the multimodal attribution system 102 utilizes all combinations of image regions to determine which combinations (e.g., the average representation of each of the combinations, such as a hidden image embedding that represents each of the combinations) matches best with the anchor (e.g., the selection of at least a portion of the answer), where the best match is determined by a similarity measure (e.g., a cosine similarity).

As shown in FIG. 6, the multimodal attribution system 102 takes a 2×2 image patch span (ii) and compares the 2×2 image patch span with the hidden answer embedding. Likewise, FIG. 6 shows the multimodal attribution system 102 comparing another 2×2 image span (i₂) with the hidden answer embedding. FIG. 6 further shows corresponding regions in a digital image 608 that the 2×2 image spans match within the digital image 608.

Although not shown in FIG. 6, in one or more embodiments, the multimodal attribution system 102 performs the act of text attribution by utilizing the anchor token (e.g., the anchor from the selection of at least a portion of the answer) to identify tokens in the digital document that highly match with the anchor (e.g., the selection of at least a portion of the answer). For instance, the multimodal attribution system 102 utilizes a neighborhood threshold to capture a text span around a token that highly matches with the anchor.

To illustrate, for the token “United Kingdom,” the multimodal attribution system 102 identifies portions in the digital document that match or are close to United Kingdom (U.K., England, Britain, United Kingdom) and further expands the text span to 10 words within the identified portions that match or are close to United Kingdom. In one or more embodiments, the multimodal attribution system 102 utilizes a wide range of neighborhood thresholds (e.g., a certain number of characters, a paragraph, a certain number of sentences, etc.). Moreover, the multimodal attribution system 102 takes the text span, and determines an average of the embeddings to generate a hidden text embedding.

FIGS. 1-6 describe the principles utilized by the multimodal attribution system 102 to generate text/image attributions by accessing hidden state embeddings. In one or more embodiments, the multimodal attribution system 102 represents the principles discussed above mathematically, where D=T, I represents a multimodal digital document. Specifically, the multimodal document (D) includes text (T) and image(s) (I). Furthermore, given a prompt (Q) and an answer (A) to the prompt generated by a multimodal model (M), the multimodal attribution system 102 has an objective to attribute any phrase (e.g., a selection of at least a portion of the answer) a∈A to its source within the digital document (D). For instance, the attribution includes a text span t∈T, an image region i∈I, or a combination of the two.

In one or more embodiments, the multimodal attribution system 102 leverages an open-source large multimodal model (MM) for attribution generation without requiring additional training or architectural modifications. In other words, the multimodal attribution system 102 performs attribution tasks by utilizing an off-the-shelf large multimodal model based on the principles described above in FIGS. 1-6.

For instance, the multimodal attribution system 102 performs a first step of processing input for multimodal attribution, where the multimodal attribution system 102 represents a concatenated input sequence as X, where X=concat(D, Q, A). As indicated above, D represents the digital document, Q represents a prompt, and A represents an artificial intelligence generated answer (e.g., responsive to the prompt). Furthermore, the multimodal attribution system 102 performs a second step of performing a forward pass of X through the multimodal large language model MM. In doing so, the multimodal attribution system 102 generates the last token of A. For instance, the multimodal attribution system 102 represents the second step as F_{MM}: X→H, where H=h₁, . . . , h_{L} represents the hidden state embeddings from L intermediate layers of MM's language model component.

In addition, the multimodal attribution system 102 performs a third step of embedding extraction from intermediate layers of the multimodal large language model. For instance, for a target phrase a of the answer A, the multimodal attribution system 102 represents embedding extraction as a: Eₐ=ƒₐ(H), where ƒₐ is a function that the multimodal attribution system 102 utilizes to extract and process relevant embeddings for a. For image regions i∈I: Eᵢ=ƒᵢ(H), where ƒᵢ extracts and processes embeddings for image regions.

Furthermore, the multimodal attribution system 102 performs a fourth step of similarity computation for each candidate attribution source. For instance, the multimodal attribution system 102 represents similarity computation of candidate attribution source as s∈t, i: sim(s, a)=g(Eₛ, Eₐ), where g is a similarity function (e.g., cosine similarity). Moreover, the multimodal attribution system 102 performs a fifth step of attribution selection (e.g., multimodal attribution). For instance, the multimodal attribution system 102 represents attribute selection as Attribution(a)=ₛ sim(s,a).

The following description reiterates the process of the multimodal attribution system 102 performing inference-time candidate text-span and image-region retrieval. Specifically, the multimodal attribution system 102 performs text attribution and image attribution at inference time (e.g., in response to a selection of at least a portion of an artificial intelligence generated answer).

For instance, the multimodal attribution system 102 performs text attribution by leveraging hidden state embeddings from the multimodal large language model to identify relevant text spans. For example, the multimodal attribution system 102 computes a vector embedding (eₐ) of the phrase a (e.g., the anchor i.e., the selection of at least a portion of the answer) to be attributed by averaging its constituent token representations (e.g., hidden state embeddings) across middle layers. Furthermore, the multimodal attribution system 102 calculates cosine similarities between (eₐ) and embeddings of all tokens in the document D, and further selects top-k tokens as anchors.

In one or more embodiments, for text-region anchors, the multimodal attribution system 102 expands token windows of varying sizes (3-10 tokens) along the neighbor tokens. Specifically, the token windows constitute the text-spans corresponding to the combined tokens. For each of the token windows, the multimodal attribution system 102 computes a single embedding representation (e.g., the hidden text embedding) and the window with the highest similarity to the (eₐ) is chosen as a representation candidate.

In one or more embodiments, the multimodal attribution system 102 identifies overlapping token windows, merges the overlapping token windows and recalculates cosine similarity scores for the resulting phrases. Specifically, the multimodal attribution system 102 determines a final attribution by selecting the merged phrase with the maximum similarity score, represented as attribution(a)=_{p∈P} sim(p, a), where P is the set of merged phrases and sim is the cosine similarity function. The above-described method enables the multimodal attribution system 102 to perform efficient and accurate text attribution at inference time, without additional training or fine-tuning, aligning with a fast, scalable attribution system for multimodal contexts.

Moreover, in one or more embodiments, the multimodal attribution system 102 performs image attribution by leveraging the hidden state embeddings of image patches, analogous to the text attribution method. For instance, the multimodal attribution system 102 utilizes a sliding window approach, considering boxes of varying sizes, ranging from 3×3 patches to the maximum number of patches in the image. Further, for each box configuration, the multimodal attribution system 102 computes a vector representation (e_{b}) by averaging the embeddings of all patches within the box. Specifically, the similarity between a box embedding and the answer phrase embedding (eₐ) is then calculated using cosine similarity, represented as sim(e_{b}, eₐ).

In one or more embodiments, the multimodal attribution system 102 repeats the sliding window process for all possible box sizes (e.g., the brute force approach described above) and positions across the digital image. The group of patches yielding the maximum similarity score is identified as the most relevant image region for attribution. Further, the multimodal attribution system 102 draws a bounding box around this region, providing a visual representation of the image attribution. In one or more embodiments, the multimodal attribution system 102 is able to perform the brute force approach due to heavily parallelizing on GPUs, leading to fast attribution generation, which also enables efficient training-free attribution for image regions that contribute most significant to the answer generation process.

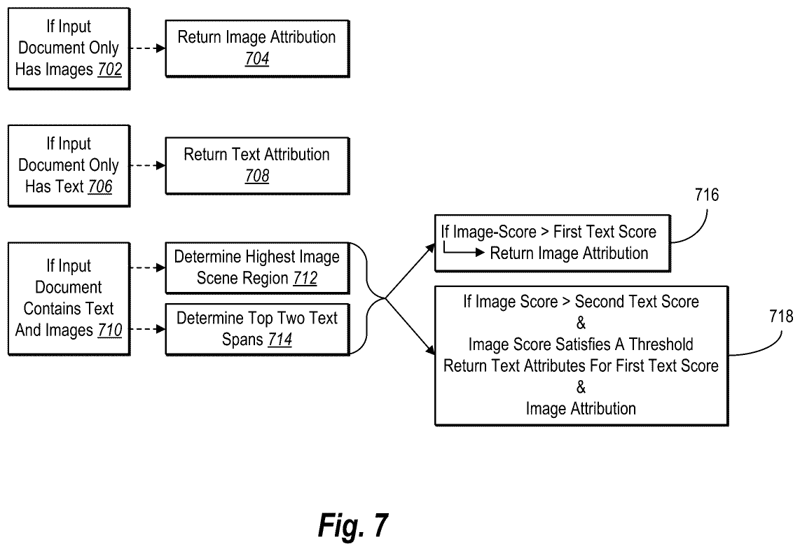

FIG. 7 illustrates the multimodal attribution system 102 utilizing a cross-modality attribution selection heuristic in accordance with one or more embodiments. In other words, the multimodal attribution system 102 intelligently determines whether to show a text attribution, an image attribution or both the text and image attribution in a digital document (e.g., in response to a selection of an answer generated by the model).

As shown in FIG. 7, the multimodal attribution system 102 determines if an input digital document only contains images 702. If so, the multimodal attribution system 102 determines to perform the act 704 of returning an image attribution. Specifically, the multimodal attribution system 102 processes the digital document, generates an answer to a prompt relative to the digital document, receives a selection of at least a portion of the answer, accesses hidden state embeddings (e.g., hidden image embeddings) from the intermediate layers of the multimodal large language model, and determines an image region with the highest measure of similarity with a hidden answer embedding.

As shown in FIG. 7 the multimodal attribution system 102 determines if an input digital document only has text 706. If so, the multimodal attribution system 102 determines to perform the act 708 of returning a text attribution. Specifically, the multimodal attribution system 102 processes the digital document, generates an answer to a prompt relative to the digital document, receives a selection of at least a portion of the answer, accesses hidden state embeddings (e.g., hidden text embeddings) from the intermediate layers of the multimodal large language model, and determines a text span with the highest measure of similarity with a hidden answer embedding.

As shown in FIG. 7, the multimodal attribution system 102 performs an act 710 of determining if an input digital document contains text and images. If so, the multimodal attribution system 102 performs an act 712 of determining highest image score region in the digital image (e.g., by comparing the hidden image embeddings with the hidden answer embedding) and performing an act 714 of determining top two text spans in the digital document (e.g., by comparing hidden text embeddings with the hidden answer embedding).

Furthermore, as shown in FIG. 7, the multimodal attribution system 102 (e.g., based on the act 712 and the act 714) performs an act 716 of returning an image attribution if the image score is greater than the first text score (e.g., the highest text score) and performs an act 718 of returning a text attribution of the first text score and an image attribution if the image score is greater than the second text score and the image score satisfies a threshold (e.g., greater than 0.95 similarity with the hidden answer embedding).

FIG. 7 illustrates the cross-modality attribution selection heuristic. In one or more embodiments, the multimodal attribution system 102 performs the cross-modality attribution selection heuristic by performing a first step of determining if an input (e.g., a digital document) has only an image. If the input only has an image, then the multimodal attribution system 102 only performs image attribution. Further, in some embodiments, the multimodal attribution system 102 performs a second step of determining if the input has only text. If the input only has text, the multimodal attribution system 102 only performs text attribution.

In one or more embodiments, the cross-modality attribution selection heuristic further includes a third step of determining that the input has both text and image. If so, the multimodal attribution system 102 determines the similarity scores for the candidates within the input. Moreover, in some embodiments, the cross-modality attribution selection heuristic further includes a fourth step of determining a highest score image region. For instance, the fourth step includes determining an image score (e.g., image_score) by obtaining the image attribution (e.g., get_image_attribution( )).

Further, in one or more embodiments, the cross-modality attribution selection heuristic further includes a fifth step of determining top two text-spans within the input. For instance, the multimodal attribution system 102 determines a first text score (Text_score_1) and further determines a second text score (text_Score_2) by obtaining the image attribution for each of the text spans (e.g., get_Text_attribution( )). Moreover, in some embodiments, the cross-modality attribution selection heuristic includes a sixth step of comparing the highest score image region (e.g., image_score) with the top text span (e.g., text_score_1). If the image score is greater than the top text span, then the multimodal attribution system 102 only performs the image attribution and returns the image attribution to the client device.

Furthermore, in some embodiments, the cross-modality attribution selection heuristic includes a seventh step of text attribution. For instance, the multimodal attribution system 102 determines that the second highest text score (e.g., text_Score_2) is not null and if the image score is greater than the second text score and the image score is greater than a threshold amount (e.g., 0.95), the multimodal attribution system 102 returns the image attribution along with the top text attribution.

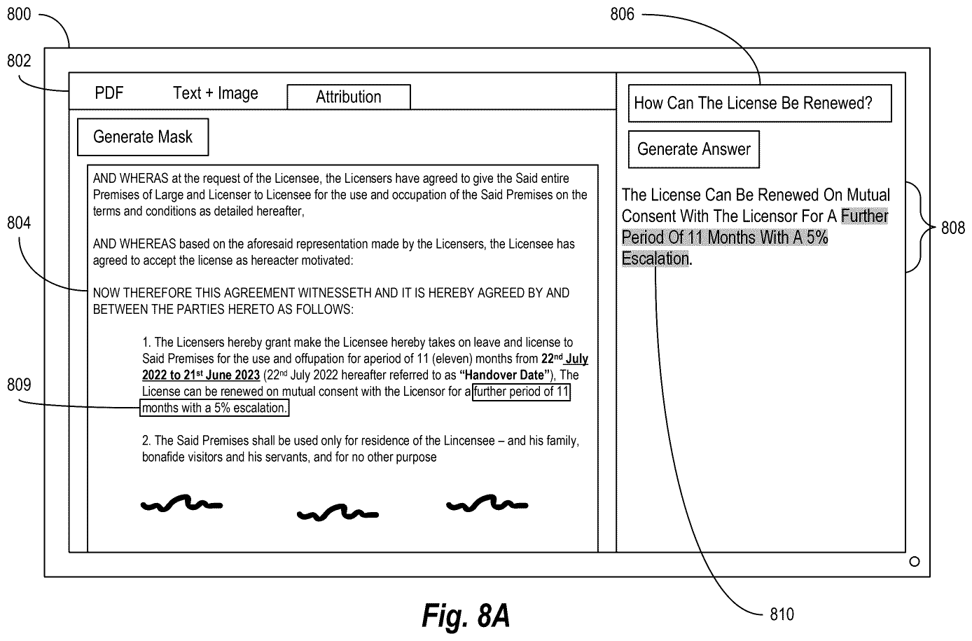

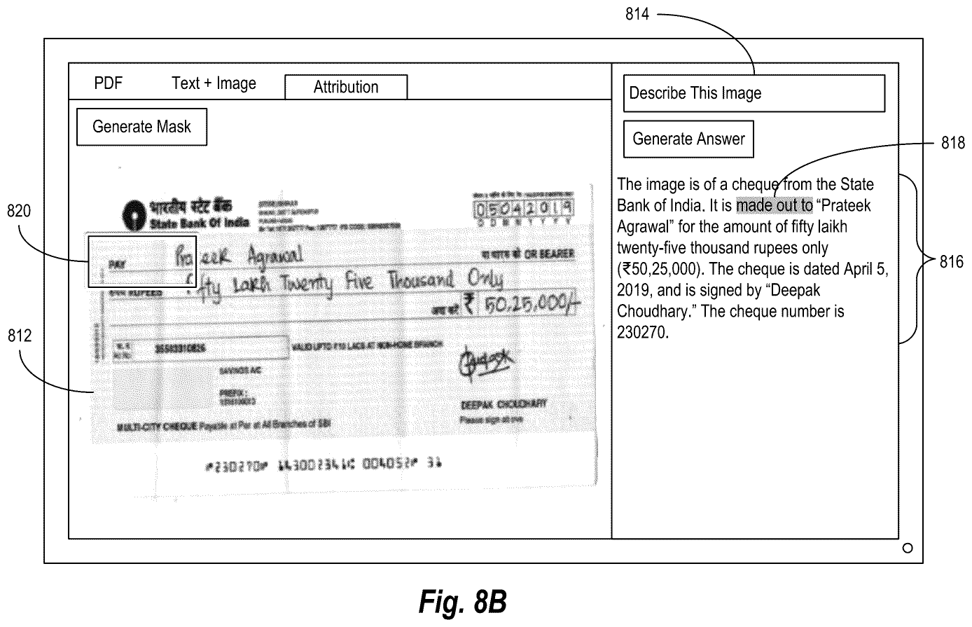

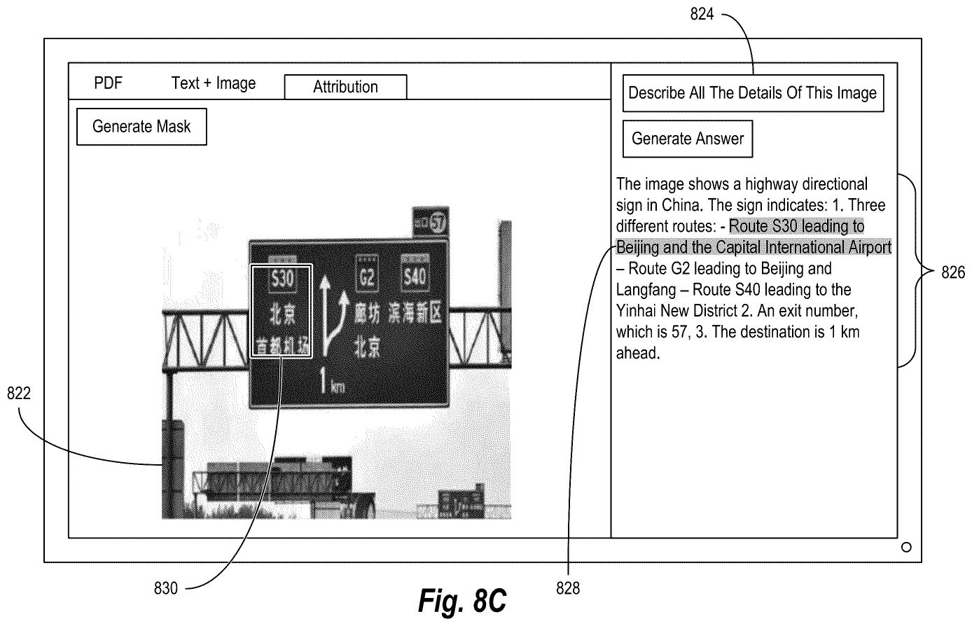

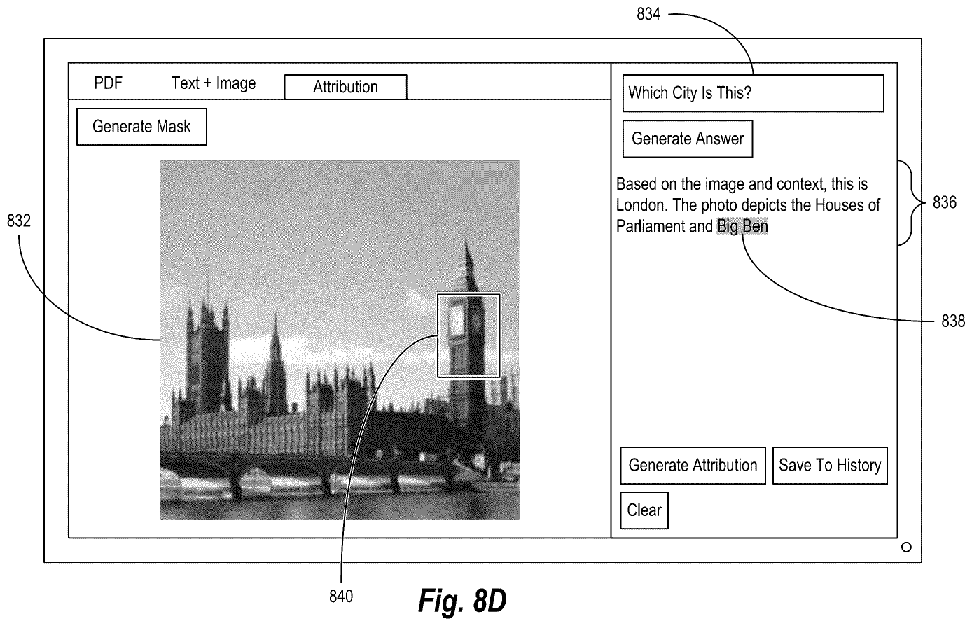

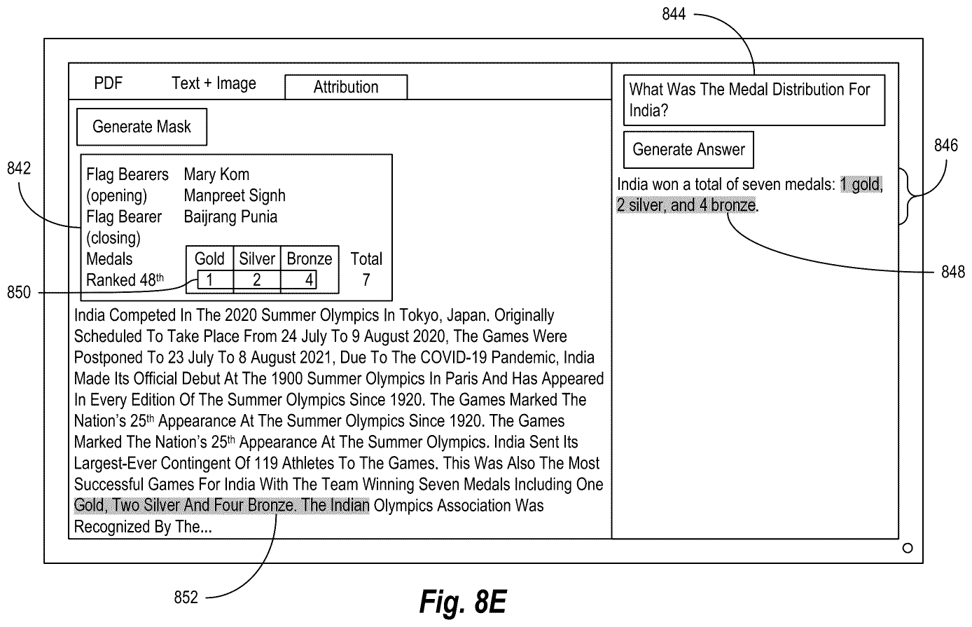

FIGS. 8A-8E illustrate example graphical user interfaces of the multimodal attribution system 102 performing attribution tasks. Specifically, as mentioned above, the multimodal attribution system 102 performs attribution tasks for a wide variety of digital documents (e.g., digital documents that include a wide variety of image element types). For instance, the multimodal attribution system 102 performs attribution tasks for natural images, charts, infographics, scanned digital documents, and images with multilingual text.

In one or more embodiments, a natural image refers to an image that represents real-world scenes, objects, or environments. For example, a natural image captures textures, colors, and structures in the physical world and further shows different types of lighting, perspective and noise in context of the type of natural image captured.

In one or more embodiments, a chart refers to a graphical representation of data to visualize various patterns, trends, or distributions. Specifically, a chart includes bar graphs, line graphs, pie charts, and other types of graphical depictions. In one or more embodiments, an infographic refers to a visual representation of data. Specifically, the infographic includes text, visual elements, and other graphical elements.

In one or more embodiments, a scanned digital document refers to a digital version of a physical document converted into an electronic format. For instance, a scanned digital document is an image of a physical document that can be viewed electronically. To illustrate, a scanned digital document includes a scanned check, a scanned legal document, a scanned scientific paper, a scanned receipt, and a scanned book. In one or more embodiments, an image with multilingual text refers to a digital image or a visual depiction that shows text in multiple languages.

For example, FIG. 8A shows a client device 800 displaying via a graphical user interface 802 a digital document 804. Specifically, FIG. 8A shows a prompt 806 relative to the digital document 804 that reads “how can the license be renewed?” and further shows the multimodal attribution system 102 generating an answer 808 that reads “the license can be renewed on mutual consent with the licensor for a furth period of 11 months with a 5% escalation.”

Moreover, FIG. 8A shows a selection 810 of a portion of the answer 808 that includes “further period of 11 months with a 5% escalation.” For instance, the selection 810 indicates that a user of the client device 800 seeks to know where in the digital document 804 the multimodal attribution system 102 determined “further period of 11 months with a 5% escalation.” As shown in FIG. 8A, the multimodal attribution system 102 generates an outline 809 (e.g., places a bounding box) around the exact text span from where the multimodal attribution system 102 obtained the answer 808 for the specifically selected portion. In one or more embodiments, the digital document 804 is a scanned digital document, thus the multimodal attribution system 102 generates an image attribution for the selected portion of the answer 808.

FIG. 8B illustrates a prompt 814 relative to a digital document 812, where the digital document 812 relates to a scanned document (i.e., a check). Specifically, the prompt 814 reads “describe this image” and the multimodal attribution system 102 generates an answer 816 that reads “the image is a cheque from the state bank of India. It is made out to “Prateek Agrawal” for the amount of fifty lakh twenty-five thousand rupees only (50,25,000). The cheque is dated Apr. 5, 2019, and is signed by “Deepak Choudhary” The cheque number is 230270.

Furthermore, FIG. 8B shows a selection 818 of a portion of the answer 816. Specifically, the selection 818 relates to the phrase in the answer 816 of “made out to.” In response, the multimodal attribution system 102 utilizes the selection 818 to identify hidden state embeddings and compare the hidden image embeddings with a hidden answer embedding. In doing so, the multimodal attribution system 102 generates an image attribution for a region of the digital image that is most similar to the selection 818 of “made out to.” For instance, FIG. 8B shows an outline 820 around “PAY” in the scanned check to indicate that the answer “made out to” comes from the portion of the scanned check that says “PAY.”

FIG. 8C illustrates a prompt 824 relative to a digital document 822, where the digital document 822 relates to a multilingual text in a digital image. Specifically, the prompt 824 reads “describe all the details of this image.” Furthermore, the multimodal attribution system 102 processes the prompt 824 to generate an answer 826 that reads “the image shows a highway directional sign in China. The sign indicates: 1. Three different routes:—Route 530 leading to Beijing and the Capital International Airport—Route G2 leading to Beijing and Langfang—Route S40 leading to the Yinhai New District 2. An exit number, which is 57. 3. The destination is 1 km ahead.”

Furthermore, FIG. 8C shows a selection 828 of a portion of the answer 826, where the selection 828 reads “Route S30 leading to Beijing and the Capital International Airport.” In response to the selection 828, the multimodal attribution system 102 identifies hidden state embeddings, compares hidden image embeddings with the hidden answer embedding, and generates an image attribution. For instance, the multimodal attribution system 102 generates an outline 830 and provides for display the outline 830 on the digital document 822 within the graphical user interface. Specifically, the outline 830 outlines (e.g., surrounds with a bounding box) the relevant portion of Route S30 leading to Beijing and the Capital International Airport, despite the text in the image being in a different language.

FIG. 8D illustrates a prompt 834 relative to a digital document 832, where the digital document 832 relates to a natural image. Specifically, the prompt 834 reads “what city is this?” In response to the prompt 834, the multimodal attribution system 102 generates an answer 836 that reads “based on the image and context, this is London. The photo depicts the Houses of Parliament and Big Ben.”

Furthermore, FIG. 8D shows a selection 838 of a portion of the answer 836, where the selection 838 reads “Big Ben.” In response to the selection 838 of the answer 836, the multimodal attribution system 102 identifies hidden state embeddings, compares hidden image embeddings with a hidden answer embedding and generates an outline 840. For instance, FIG. 8D shows the multimodal attribution system 102 providing for display in the digital document 832 the outline 840 that outlines Big Ben in the digital image.

FIG. 8E illustrates a prompt 844 relative to a digital document 842, where the digital document 842 relates to a document with text and image elements. Specifically, the prompt 844 reads “what was the medal distribution for India?” In response to the prompt 844, the multimodal attribution system 102 generates an answer 846 that reads “India won a total of seven medals: 1 gold, 2 silver, and 4 bronze.”

Furthermore, the multimodal attribution system 102 receives a selection 848 of a portion of the answer 846. Specifically, the selection 848 reads “1 gold, 2 silver, and 4 bronze.” In response to the selection 848, the multimodal attribution system 102 identifies hidden state embeddings, compares hidden text embeddings and hidden image embeddings with a hidden answer embedding and generates a text attribution and an image attribution. For instance, the multimodal attribution system 102 generates an outline 850 around the table that shows the gold, silver, and bronze medals for India and further generates a highlight 852 for the text that describes the number of medals won by India.

In one or more embodiments, experimenters evaluated the results of the multimodal attribution system 102. For instance, the experimenters use a pipeline that uses a generative pretrained transformer (GPT) as a judge model for attribution results generated by the multimodal attribution system 102. Specifically, the experimenters provide context (e.g., text and image), the prompt, the answer, and the attribution generated by the multimodal attribution system 102, along with a specific prompt. For each evaluation, the experimenters use GPT to receive the original image, the prompt, the answer, phrase to be attributed, and the attribution provided by the multimodal attribution system 102, accompanied by a detailed prompt (e.g., to judge the results of the multimodal attribution system 102).

For instance, the detailed prompt includes four specific aspects of attribution to be evaluated (e.g., scoring attribution on a scale from 0-5 for each aspect). Multiple evaluations (three per sample) are conducted, and the scores for each aspect are averaged across these evaluations. Specifically, the final score for each sample is computed as the mean of these averaged aspect scores. In one or more embodiments, the experimenters determined the following quantitative results utilizing the above discussed evaluation:

| VLM | Backbone/Datasets | TextVQA-300 | ChartVQA-300 | Real VQA-300 |
|---|---|---|---|---|
| Llava-Next | MISTRAL-7B | 2.89 | 1.93 | 2.76 |
| MGM | YI-34B | 2.77 | 2.21 | 2.74 |
| Multimodal | InternLM-7B | 3.44 | 2.66 | 2.93 |
| attribution | | | | |
| system 102 | | | | |

In the above table, the experimenters tested on a variety of diverse data subsets that involve text on images, charts, and real-world imagery. Specifically, the above table shows TextVQA which is a text dataset, ChartVQA which is a dataset for charts (e.g., a type of digital image), and Real VQA which is a dataset for real-world digital images. For instance, the above table shows the multimodal attribution system 102 outperforming existing models (e.g., as judged by the GPT model) for text attribution and image attribution tasks.

For instance, the existing models include Llava-Next which is described in Liu, Haotian, et al., Visual Instruction Tuning, Advances in neural information processing systems 36, (2024), and Liu, Haotian, et al., Improved Baselines with Visual Instruction Tuning, Proceedings of the IEEE/CVF Conference on Computer Vision and Pattern Recognition, (2024). Moreover, the existing models include MGM (Mini-gemini) as described in Li, Yanwei, et al., Mini-gemini: Mining the Potential of Multi-Modality Vision Language Models, arXiv preprint arXiv: 2403.18814 (2024).

In one or more embodiments, experimenters further validated the efficacy of their evaluation methodology. Specifically, the experimenters used phrases paired with images containing segmented objects referenced by those phrases. For instance, the experimenters created the closest possible bounding boxes by dividing each image into patches, selecting all patches containing the segmentation, and then drew a rectangular bounding box using the maximum and minimum x and y coordinates of the selected patches.

Furthermore, to create a comprehensive evaluation set, experimenters generated approximately six additional bounding boxes for each data sample, with intersection over union (IoU) values ranging from 0 to 1, in increments of 0,2. For instance, by utilizing this process, the experimenters effectively created incorrect bounding boxes for the same phrase, allowing the experimenters to test the robustness of the attribution method. Specifically, the experimenters applied this technique to 80 data samples (images and phrases), resulting in a total of 552 data points. Further, the experimenters modified the evaluation prompt to focus solely on attribution and the phrase, removing extraneous information.

In one or more embodiments, the experimenters used the refined prompt, along with the image containing the bounding box and the original phrase from the dataset and passed it along to a GPT model for evaluation. To ensure reliability, experimenters calculated scores based on established criteria using multiple calls (three per sample) across all 552 samples. Finally, experimenters quantified the relationship between the performance of the multimodal attribution system 102 and the accuracy of the bounding boxes by computing a Pearson correlation coefficient between IoU values and the calculated scores. The resulting coefficient of around 0.7 indicated a strong positive correlation, suggesting that the attribution method of the multimodal attribution system 102 effectively distinguishes between accurate and inaccurate visual attributions.

In one or more embodiments, the attribution quality of an artificial intelligence model improves as the answering capability of the artificial intelligence model improves. Thus, the higher the quality of an artificial intelligence model in generating answers, the higher the capability of performing text and image attribution tasks using the principles discussed above. Thus, the multimodal attribution system 102 improves image and text attribution capabilities without requiring retraining or architectural modifications to question and answering environments (e.g., artificial intelligence networks of question and answering environments).

Turning to FIG. 9, additional detail will now be provided regarding various components and capabilities of the multimodal attribution system 102. In particular, FIG. 9 illustrates an example schematic diagram of a computing device 900 (e.g., the server(s) 104 and/or the client device 110) implementing the multimodal attribution system 102 in accordance with one or more embodiments of the present disclosure for components 900-918. As illustrated in FIG. 9, the multimodal attribution system 102 includes an AI answer manager 902, a multimodal model 904, a multimodal large language model 906, a hidden answer embedding manager 908, a hidden text embedding manager 910, a hidden image embedding manager 912, an attribution manager 914, an attribution display manager 916, and a storage manager 918.

The AI answer manager 902 generates an answer to a prompt. For example, the AI answer manager 902 utilizes an artificial intelligence model to generate an answer to a prompt relative to a digital document. Specifically, the AI answer manager 902 provides a question and answering environment for a client device to submit queries/prompts regarding an opened digital document and further generates an answer responsive to the prompt. For instance, the AI answer manager 902 processes a digital document along with the prompt to determine an answer to the prompt.

The multimodal model 904 processes a digital document with multiple modalities. For example, the multimodal model 904 processes text features and image elements in a digital document to generate an answer. In one or more embodiments, the multimodal model 904 works in tandem with the AI answer manager 902 to determine an answer responsive to a prompt relative to a digital document. Moreover, in one or more embodiments, the multimodal model 904 operates in a separate environment from a model utilized for generating text and/or image attributions. In one or more embodiments, the multimodal attribution system 102 utilizes the multimodal model 904 for both generating the answer and performing attribution tasks.

The multimodal large language model 906 processes a digital document with multiple modalities. For example, the multimodal large language model 906 processes a digital document with text and image elements and further processes a prompt, and an answer generated from the multimodal model. Further, the multimodal large language model 906 generates a plurality of hidden state embeddings by processing inputs through intermediate layers of a multimodal model. In doing so, the multimodal large language model 906 generates text and image attributions for a selection of at least a portion of an answer.

The hidden answer embedding manager 908 manages intermediate layers of a multimodal model. For example, the hidden answer embedding manager 908 filters through hidden state embeddings of the intermediate layers to identify a subset of hidden state embeddings. Furthermore, the hidden answer embedding manager 908 combines the subset of hidden state embeddings to generate a hidden answer embedding. Further, the hidden answer embedding manager 908 works with other components to further perform the text and image attributions.

The hidden text embedding manager 910 manages intermediate layers of a multimodal model. For example, the hidden text embedding manager 910 identifies hidden state embeddings relating to text elements within a digital document. For instance, the hidden text embedding manager 910 combines hidden state embeddings in such a manner to generate hidden text embeddings and further compares the hidden text embeddings with a hidden answer embedding. Thus, in one or more embodiments, the hidden text embedding manager 910 works in tandem with other components to determine a text attribution.

The hidden image embedding manager 912 manages intermediate layers of a multimodal model. For example, the hidden image embedding manager 912 identifies hidden state embeddings relating to image elements within a digital document. For instance, the hidden image embedding manager 912 combines hidden state embeddings in such a manner to generate hidden image embeddings and further compares the hidden image embeddings with a hidden answer embedding. In doing so the hidden image embedding manager 912 works in tandem with other components to determine an image attribution.

The attribution manager 914 generates an image attribution of an image element in the digital document and a text attribution of a text in the digital document. For example, the attribution manager 914 uses the multimodal large language model 906 to determine an image region and a text span that provide support for at least a portion of an answer generated by a multimodal model. Further, in one or more embodiments, the attribution manager 914 determines a bounding box (e.g., for an image attribution) and a type of emphasis (e.g., highlighting, underlining, etc.) for a text attribution.

The attribution display manager 916 provides for display in a digital document an image attribution of an image element and/or a text attribution of text. For example, the attribution display manager 916 causes a graphical user interface of a client device to display a digital document and further causes the graphical user interface to display the text/image attribution.

The storage manager 918 stores various components generated by the multimodal attribution system 102. For example, the storage manager 918 stores model parameters for a multimodal model (e.g., multimodal large language model), questions (prompts), digital documents (processed), answers generated in response to prompts, hidden state embeddings (e.g., hidden text embeddings, hidden image embeddings, and a hidden answer embedding), text attributions, image attributions, and additional training/initiation data for preparing a multimodal model to generate an answer to a prompt relative to a digital document.

Each of the components 902-918 of the multimodal attribution system 102 can include software, hardware, or both. For example, the components 902-918 can include one or more instructions stored on a computer-readable storage medium and executable by processors of one or more computing devices, such as a client device or server device. When executed by the one or more processors, the computer-executable instructions of the multimodal attribution system 102 can cause the computing device(s) to perform the methods described herein. Alternatively, the components 902-918 can include hardware, such as a special-purpose processing device to perform a certain function or group of functions. Alternatively, the components 902-918 of the multimodal attribution system 102 can include a combination of computer-executable instructions and hardware.

Furthermore, the components 902-918 of the multimodal attribution system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 902-918 of the multimodal attribution system 102 may be implemented as a stand-alone application, such as a desktop or mobile application. Furthermore, the components 902-918 of the multimodal attribution system 102 may be implemented as one or more web-based applications hosted on a remote server. Alternatively, or additionally, the components 902-918 of the multimodal attribution system 102 may be implemented in a suite of mobile device applications or “apps.” For example, in one or more embodiments, the multimodal attribution system 102 can comprise or operate in connection with digital software applications such as ADOBE® ACROBAT STANDARD, ADOBE® DOCUMENT CLOUD, ADOBE® ACROBAT MOBILE, and/or ADOBE® ACROBAT.

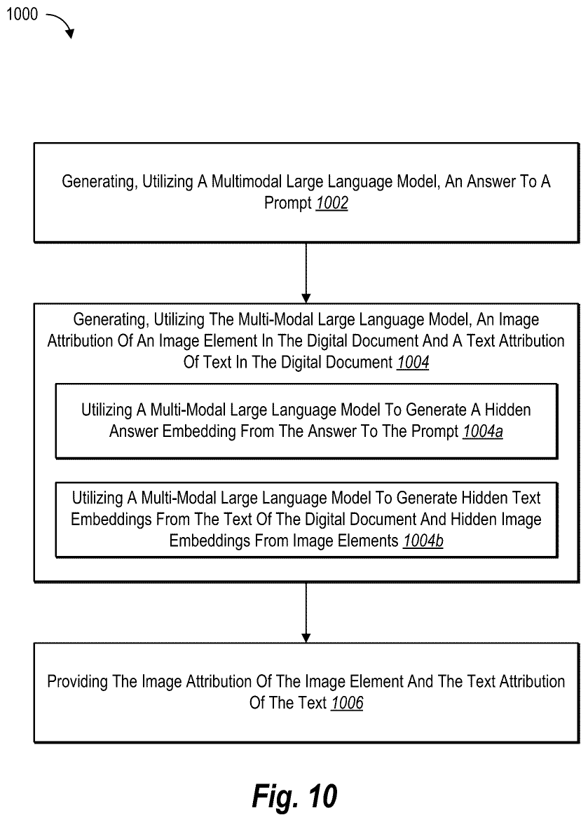

FIGS. 1-9, the corresponding text, and the examples provide a number of different methods, systems, devices, and non-transitory computer-readable media of the 902-918. In addition to the foregoing, one or more embodiments can also be described in terms of flowcharts comprising acts for accomplishing the particular result, as shown in FIG. 10. FIG. 10 may be performed with more or fewer acts. Further, the acts may be performed in different orders. Additionally, the acts described herein may be repeated or performed in parallel with one another or in parallel with different instances of the same or similar acts.

FIG. 10 illustrates a flowchart of a series of acts 1000 for providing an image attribution of an image element and a text attribution of text in a digital document in accordance with one or more embodiments. FIG. 10 illustrates acts according to one embodiment, alternative embodiments may omit, add to, reorder, and/or modify any of the acts shown in FIG. 10. In some implementations, the acts of FIG. 10 are performed as part of a method. For example, in one or more embodiments, the acts of FIG. 10 are performed as part of a computer-implemented method. Alternatively, a non-transitory computer-readable medium can store instructions thereon that, when executed by at least one processor, cause a computing device to perform the acts of FIG. 10. In one or more embodiments, a system performs the acts of FIG. 10. For example, in one or more embodiments, a system includes at least one memory device. The system further includes at least one server device configured to cause the system to perform the acts of FIG. 10.

The series of acts 1000 includes an act 1002 of generating, utilizing a multimodal large language model, an answer to a prompt. Further, the series of acts 1000 includes an act 1004 of generating, utilizing the multi-modal large language model, an image attribution of an image element in the digital document and a text attribution of text in the digital document. Moreover, the act 1004 includes a sub-act 1004a of utilizing a multi-modal large language model to generate a hidden answer embedding from the answer to the prompt. Moreover, the act 1004 includes a sub-act 1004b of utilizing a multi-modal large language model to generate hidden text embeddings from the text of the digital document and hidden image embeddings from image elements. Moreover, the series of acts 1000 includes an act 1006 of providing the image attribution of the image element and the text attribution of the text.

In particular, the act 1002 includes in response to receiving a prompt relative to a digital document comprising text and image elements, generating, utilizing a multimodal large language model, an answer to the prompt. Further, the act 1004 includes in response to a selection of at least a portion of the answer to the prompt, generating, utilizing, the multimodal large language model, an image attribution of an image element in the digital document and a text attribution of text in the digital document, wherein the image attribution and the text attribution indicate portions of the digital document that provide support for the at least a portion of the answer. Moreover, the act 1006 includes providing, for display in the digital document of a client device, the image attribution of the image element and the text attribution of the text.

For example, in one or more embodiments, the series of acts 1000 includes determining, in the digital document, one or more text spans and one or more regions of a digital image that provide support to the answer. In addition, in one or more embodiments, the series of acts 1000 includes generating the image attribution that indicates a portion of the digital document for one of a natural image, a chart, an infographic, a scanned digital document, or an image with multilingual text. Further, in one or more embodiments, the series of acts 1000 includes generating the answer to the prompt relative to the digital document occurs simultaneously with generating the image attribution of the image element and the text attribution of the text. Further, in one or more embodiments, the series of acts 1000 includes providing, for display on a graphical user interface of a client device, the digital document in tandem with a prompt panel for the client device to submit a question about the digital document.

Moreover, in one or more embodiments, the series of acts 1000 includes utilizing the selection of the at least a portion of the answer as an anchor to identify a subset of hidden state embeddings from a plurality of hidden state embeddings from intermediate layers of the multimodal large language model. Further, in one or more embodiments, the series of acts 1000 includes generating a hidden answer embedding for the anchor by averaging the subset of hidden state embeddings. Moreover, in one or more embodiments, the series of acts 1000 includes identifying hidden text embeddings from the plurality of hidden state embeddings by utilizing a first function to filter down the plurality of hidden state embeddings. Further, in one or more embodiments, the series of acts 1000 includes comparing the hidden text embeddings with the hidden answer embedding to generate measures of similarity.

Moreover, in one or more embodiments, the series of acts 1000 includes based on the measures of similarity, generating the text attribution that indicates a text portion in the digital document with the highest measure of similarity of the measures of similarity. Additionally, in one or more embodiments, the series of acts 1000 includes identifying hidden image embeddings from the plurality of hidden state embeddings by utilizing a second function to filter down the plurality of hidden state embeddings. Moreover, in one or more embodiments, series of acts 1000 includes comparing the hidden image embeddings with the hidden answer embedding to generate measures of similarity. Further, in one or more embodiments, the series of acts 1000 includes based on the measures of similarity, generating the image attribution that indicates an image element in the digital document with the highest measure of similarity of the measures of similarity.

Furthermore, in one or more embodiments, the series of acts 1000 includes highlighting a relevant text span in the digital document that is responsive to the selection of the selection of the at least a portion of the answer. Moreover, in one or more embodiments, the series of acts 1000 includes outlining a relevant image region in the digital document that is responsive to the selection of the selection of the at least a portion of the answer.

Moreover, in one or more embodiments, the series of acts 1000 includes generating, utilizing a multimodal large language model, a hidden answer embedding from an answer obtained in response to a prompt relative to a digital document, the digital document comprising text and image elements. Further, in one or more embodiments, the series of acts 1000 includes generating, utilizing the multimodal large language model, hidden text embeddings from the text of the digital document and hidden image embeddings from the image elements of the digital document. Moreover, in one or more embodiments, the series of acts 1000 includes based on comparing the hidden text embeddings with the hidden answer embedding and comparing the hidden image embeddings with the hidden answer embedding, determining at least one of a text attribution or an image attribution responsive to the prompt to query the digital document. Further, in one or more embodiments, the series of acts 1000 includes based on at least one of the text attribution or the image attribution, provide, for display in the digital document of a client device, at least one of the text attribution within the digital document or the image attribution within the digital document.

Moreover, in one or more embodiments, the series of acts 1000 includes receiving, from a client device, a selection of at least a portion of the answer obtained in response to the prompt relative to the digital document. Further, in one or more embodiments, the series of acts 1000 includes utilizing the selection of the at least a portion of the answer as an anchor to identify a subset of hidden state embeddings from a plurality of hidden state embeddings generated from intermediate layers of the multimodal large language model, wherein the subset of hidden state embeddings corresponds to tokens of the selection of the at least a portion of the answer. Moreover, in one or more embodiments, the series of acts 1000 includes generate a hidden answer embedding for the anchor by averaging the subset of hidden state embeddings. Further, in one or more embodiments, the series of acts 1000 includes to generate the hidden text embeddings by utilizing a first function to filter down the plurality of hidden state embeddings to an additional subset of hidden state embeddings of the text within the digital document.

Moreover, in one or more embodiments, the series of acts 1000 includes generating a first hidden text embedding by averaging hidden state embeddings from the additional subset of hidden state embeddings, wherein the first hidden text embedding corresponds to a first text span within the digital document. Further, in one or more embodiments, the series of acts 1000 includes generating a second hidden text embedding by averaging hidden state embeddings from the additional subset of hidden state embeddings, wherein the second hidden text embedding corresponds to a second text span within the digital document. Moreover, in one or more embodiments, the series of acts 1000 includes comparing the first hidden text embedding with the hidden answer embedding to generate a first measure of similarity. Further, in one or more embodiments, the series of acts 1000 includes comparing the second hidden text embedding with the hidden answer embedding to generate a second measure of similarity.

Moreover, in one or more embodiments, the series of acts 1000 includes generating hidden image embeddings by utilizing a second function to filter down the plurality of hidden state embeddings to an additional subset of hidden state embeddings of image elements within the digital document. Further, in one or more embodiments, the series of acts 1000 includes generating a hidden image embedding by averaging hidden state embeddings from the additional subset of hidden state embeddings, wherein the hidden image embedding corresponds to an image region within the digital document. Moreover, in one or more embodiments, the series of acts 1000 includes providing, for display in the digital document of the client device, the image attribution indicating the image region based on comparing the hidden image embedding with the hidden answer embedding.

Moreover, in one or more embodiments, the series of acts 1000 includes in response to a prompt relative to a digital document comprising text and image elements, determining, utilizing a multimodal large language model, portions of the digital document that supports an answer to the prompt. Further, in one or more embodiments, the series of acts 1000 includes generating, utilizing the multimodal large language model to process the text and the image elements, a text attribution for the answer to the prompt and an image attribution for the answer to the prompt. Moreover, in one or more embodiments, the series of acts 1000 includes providing, for display in the digital document of a client device, the image attribution of an image element and the text attribution of a portion of the text in the digital document. Further, in one or more embodiments, the series of acts 1000 includes generating a combined input by combining the digital document, the prompt relative to the digital document, and the portions of the digital document that supports the answer to the prompt.

Moreover, in one or more embodiments, the series of acts 1000 includes performing a forward pass over the multimodal large language model with the combined input to generate the text attribution and the image attribution by accessing a subset of hidden state embeddings from a plurality of hidden state embeddings from intermediate layers of the multimodal large language model, wherein the subset of hidden state embeddings is related to tokens in the prompt relative to the digital document. Further, in one or more embodiments, the series of acts 1000 includes generating, utilizing a text encoder of the multimodal large language model, text tokens for the prompt relative to the digital document and the text of the digital document. Moreover, in one or more embodiments, the series of acts 1000 includes generating, utilizing an image encoder of the multimodal large language model, image tokens for the image elements of the digital document. Further, in one or more embodiments, the series of acts 1000 includes performing a forward pass over the multimodal large language model with the text tokens, the image tokens, and the answer to the prompt to generate a plurality of hidden state embeddings from intermediate layers of the multimodal large language model.

Moreover, in one or more embodiments, the series of acts 1000 includes identifying a subset of hidden state embeddings from the plurality of hidden state embeddings, wherein the subset of hidden state embeddings is from the portions of the digital document that supports the answer to the prompt. Further, in one or more embodiments, the series of acts 1000 includes generating a hidden answer embedding from the subset of hidden state embeddings. Moreover, in one or more embodiments, the series of acts 1000 includes filtering down the plurality of hidden state embeddings to a first additional subset of hidden state embeddings of the text and a second additional subset of hidden state embeddings of the image elements in the digital document.

Further, in one or more embodiments, the series of acts 1000 includes comparing the hidden answer embedding with a hidden text embedding generated from the first additional subset of hidden state embeddings. Moreover, in one or more embodiments, the series of acts 1000 includes comparing the hidden answer embedding with a hidden image embedding generated from the second additional subset of hidden state embeddings. Further, in one or more embodiments, the series of acts 1000 includes based on comparing the hidden answer embedding with the hidden text embedding and the hidden image embedding, providing, for display in the digital document of the client device, the image attribution and the text attribution.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., the server(s) 104 and/or the client device 110). In one or more embodiments, the computing device 1100 may be a mobile device (e.g., a mobile telephone, a smartphone, a PDA, a tablet, a laptop, a camera, a tracker, a watch, a wearable device). In one or more embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 include hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
in response to receiving a prompt relative to a digital document comprising text and image elements, generating, utilizing a multimodal large language model, an answer to the prompt;
in response to a selection of at least a portion of the answer to the prompt, generating, utilizing, the multimodal large language model, an image attribution of an image element in the digital document and a text attribution of text in the digital document, wherein the image attribution and the text attribution indicate portions of the digital document that provide support for the at least a portion of the answer; and
providing, for display in the digital document of a client device, the image attribution of the image element and the text attribution of the text.

2. The computer-implemented method of claim 1, wherein generating the answer to the prompt comprises determining, in the digital document, one or more text spans and one or more regions of a digital image that provide support to the answer.

3. The computer-implemented method of claim 1, wherein generating the image attribution of the image element in the digital document comprises generating the image attribution that indicates a portion of the digital document for one of a natural image, a chart, an infographic, a scanned digital document, or an image with multilingual text.

4. The computer-implemented method of claim 1, wherein generating the answer to the prompt relative to the digital document occurs simultaneously with generating the image attribution of the image element and the text attribution of the text.

5. The computer-implemented method of claim 1, wherein receiving the prompt relative to the digital document comprises providing, for display on a graphical user interface of a client device, the digital document in tandem with a prompt panel for the client device to submit a question about the digital document.

6. The computer-implemented method of claim 1, wherein generating the image attribution and the text attribution comprises:
utilizing the selection of the at least a portion of the answer as an anchor to identify a subset of hidden state embeddings from a plurality of hidden state embeddings from intermediate layers of the multimodal large language model; and
generating a hidden answer embedding for the anchor by averaging the subset of hidden state embeddings.

7. The computer-implemented method of claim 6, further comprises:
identifying hidden text embeddings from the plurality of hidden state embeddings by utilizing a first function to filter down the plurality of hidden state embeddings;
comparing the hidden text embeddings with the hidden answer embedding to generate measures of similarity; and
based on the measures of similarity, generating the text attribution that indicates a text portion in the digital document with a highest measure of similarity of the measures of similarity.

8. The computer-implemented method of claim 6, further comprising:
identifying hidden image embeddings from the plurality of hidden state embeddings by utilizing a second function to filter down the plurality of hidden state embeddings;
comparing the hidden image embeddings with the hidden answer embedding to generate measures of similarity; and
based on the measures of similarity, generating the image attribution that indicates an image element in the digital document with a highest measure of similarity of the measures of similarity.

9. The computer-implemented method of claim 1, wherein providing the image attribution and the text attribution for display in the digital document of the client device comprises:
highlighting a relevant text span in the digital document that is responsive to the selection of the selection of the at least a portion of the answer; and
outlining a relevant image region in the digital document that is responsive to the selection of the selection of the at least a portion of the answer.

10. A system comprising:
one or more memory devices; and
one or more processors coupled to the one or more memory devices, configured to cause the system to:
generate, utilizing a multimodal large language model, a hidden answer embedding from an answer obtained in response to a prompt relative to a digital document, the digital document comprising text and image elements;
generate, utilizing the multimodal large language model, hidden text embeddings from the text of the digital document and hidden image embeddings from the image elements of the digital document;
based on comparing the hidden text embeddings with the hidden answer embedding and comparing the hidden image embeddings with the hidden answer embedding, determine at least one of a text attribution or an image attribution responsive to the prompt to query the digital document; and
based on at least one of the text attribution or the image attribution, provide, for display in the digital document of a client device, at least one of the text attribution within the digital document or the image attribution within the digital document.

11. The system of claim 10, wherein the one or more processors are configured to cause the system to:
receive, from a client device, a selection of at least a portion of the answer obtained in response to the prompt relative to the digital document; and
utilize the selection of the at least a portion of the answer as an anchor to identify a subset of hidden state embeddings from a plurality of hidden state embeddings generated from intermediate layers of the multimodal large language model, wherein the subset of hidden state embeddings corresponds to tokens of the selection of the at least a portion of the answer.

12. The system of claim 11, wherein the one or more processors are configured to cause the system to generate a hidden answer embedding for the anchor by averaging the subset of hidden state embeddings.

13. The system of claim 11, wherein the one or more processors are configured to cause the system to generate the hidden text embeddings by:
utilizing a first function to filter down the plurality of hidden state embeddings to an additional subset of hidden state embeddings of the text within the digital document;
generating a first hidden text embedding by averaging hidden state embeddings from the additional subset of hidden state embeddings, wherein the first hidden text embedding corresponds to a first text span within the digital document; and
generating a second hidden text embedding by averaging hidden state embeddings from the additional subset of hidden state embeddings, wherein the second hidden text embedding corresponds to a second text span within the digital document.

14. The system of claim 13, wherein the one or more processors are configured to cause the system to:
compare the first hidden text embedding with the hidden answer embedding to generate a first measure of similarity;
compare the second hidden text embedding with the hidden answer embedding to generate a second measure of similarity; and
based on the first measure of similarity being greater than the second measure of similarity, providing, for display in the digital document of the client device, the text attribution indicating the first text span.

15. The system of claim 11, wherein the one or more processors are configured to cause the system to generate the hidden image embeddings by:
utilizing a second function to filter down the plurality of hidden state embeddings to an additional subset of hidden state embeddings of image elements within the digital document;
generating a hidden image embedding by averaging hidden state embeddings from the additional subset of hidden state embeddings, wherein the hidden image embedding corresponds to an image region within the digital document; and
providing, for display in the digital document of the client device, the image attribution indicating the image region based on comparing the hidden image embedding with the hidden answer embedding.

16. A non-transitory computer-readable medium storing executable instructions which, when executed by at least one processing device, cause the at least one processing device to perform operations comprising:
in response to a prompt relative to a digital document comprising text and image elements, determining, utilizing a multimodal large language model, portions of the digital document that supports an answer to the prompt;
generating, utilizing the multimodal large language model to process the text and the image elements, a text attribution for the answer to the prompt and an image attribution for the answer to the prompt; and
providing, for display in the digital document of a client device, the image attribution of an image element and the text attribution of a portion of the text in the digital document.

17. The non-transitory computer-readable medium of claim 16, wherein generating the text attribution and the image attribution comprises:
generating a combined input by combining the digital document, the prompt relative to the digital document, and the portions of the digital document that supports the answer to the prompt; and
performing a forward pass over the multimodal large language model with the combined input to generate the text attribution and the image attribution by accessing a subset of hidden state embeddings from a plurality of hidden state embeddings from intermediate layers of the multimodal large language model,
wherein the subset of hidden state embeddings is related to tokens in the prompt relative to the digital document.

18. The non-transitory computer-readable medium of claim 16, wherein generating the text attribution and the image attribution comprises:
generating, utilizing a text encoder of the multimodal large language model, text tokens for the prompt relative to the digital document and the text of the digital document;
generating, utilizing an image encoder of the multimodal large language model, image tokens for the image elements of the digital document; and
performing a forward pass through the multimodal large language model with the text tokens, the image tokens, and the answer to the prompt to generate a plurality of hidden state embeddings from intermediate layers of the multimodal large language model.

19. The non-transitory computer-readable medium of claim 18, wherein the operations further comprise:
identifying a subset of hidden state embeddings from the plurality of hidden state embeddings, wherein the subset of hidden state embeddings is from the portions of the digital document that supports the answer to the prompt;
generating a hidden answer embedding from the subset of hidden state embeddings; and
filtering down the plurality of hidden state embeddings to a first additional subset of hidden state embeddings of the text and a second additional subset of hidden state embeddings of the image elements in the digital document.

20. The non-transitory computer-readable medium of claim 19, wherein the operations further comprise:
comparing the hidden answer embedding with a hidden text embedding generated from the first additional subset of hidden state embeddings;
comparing the hidden answer embedding with a hidden image embedding generated from the second additional subset of hidden state embeddings; and
based on comparing the hidden answer embedding with the hidden text embedding and the hidden image embedding, providing, for display in the digital document of the client device, the image attribution and the text attribution.
